(19) United States
(12) Patent Application Publication
(10) Pub. No.: US 2007/0268369 A1
(43) Pub. Date: Nov. 22, 2007

(54) Automatic Imaging Method and Apparatus

(75) Inventors: Shisai Amano, Tokyo (JP); Yoshinori Sashikawa, Tokyo (JP); Mizuo Tsukidate, Tokyo (JP); Hisayo Sashik'awa, Tokyo (JP)

Correspondence Address: JORDAN AND HAMBURG LLP, 122 EAST 42ND STREET, SUITE 4000, NEW YORK, NY, 10168, US

(73) Assignee: Chuo Electronics Co., Ltd., Hachioji-shi, Tokyo (JP)

(21) Appl. No.: 11/579,169

(22) PCT Filed: Apr. 28, 2005
(86) PCT No.: PCT/JP05/08246

§ 371 Date: Oct. 30, 2006

(30) Foreign Application Priority Data
Apr. 28, 2004 (JP) 2004-132499

(51) Int. Cl. H04N 5/225

(52) U.S. Cl. 348/207.99

(57) ABSTRACT

An automatic imaging method is provided that selects and images one target in a monitoring environment where multiple target candidates exist on input video images. The method acquires tracking video images of a target by steps of: estimating, for each block obtained by dividing an imaging region of input video image I, whether a part or all of an object to be tracked and imaged appears in the block, and extracting set of blocks P in which the object is estimated to appear; presetting N number of regions Sᵢ (i=1, 2, 3 . . . N) of arbitrary shape on an imaging region of input video image I, together with priorities pᵢ (i=1, 2, 3 . . . N) of each region, examining correlations between the regions Sᵢ and set of blocks P, and extracting and outputting connecting region T′ that overlaps with a region Sᵢ having highest priority among connecting regions included in the set of blocks P and overlapping with any of regions Sᵢ; and controlling second imaging means 2 to contain an object appearing in a region covered by connecting region T′ on input video image I in a field of view of second imaging means 2.

### TECHNICAL FIELD

The present invention relates to an automatic imaging method and automatic imaging apparatus using monitoring cameras for constructing a video monitoring system.

### BACKGROUND ART

In a video monitoring system in which video images of an entire monitoring region are captured using monitoring cameras and an operator conducts monitoring based on video images of the entire monitoring region that are displayed on a monitor, there is a large burden on the operator monitoring the images when a video image of a target that is detected within the monitoring area is displayed in a small state on a monitor.

Therefore, as shown in FIG. 16, a video monitoring system has been developed that includes first imaging means comprising a wide angle camera that captures images an entire monitoring region; second imaging means comprising a camera equipped with pan, tilt, and zoom functions; and an automatic imaging apparatus main unit that detects a target based on video images input from the first imaging means, and when a target was detected, controls the imaging direction of the second imaging means in accordance with the position of the target; wherein the video monitoring system displays an enlarged image of the target that was tracked and imaged with the second imaging means on a monitor (see Patent Document 1).

Further, a video monitoring system has also been developed which instead of second imaging means comprising a camera with pan, tilt, and zoom functions, includes electronic cutout means (video image extracting means) that partially extracts a video image of a target from video images input from first imaging means. When this system detects a target based on video images input from the first imaging means, it partially extracts a video image of the target from the overall video images using the video image extracting means, and displays enlarged tracking video images of the target on a monitor.

Patent Document 1: Japanese Patent Laid-Open No. 2004-7374

### DISCLOSURE OF THE INVENTION

In the type of automatic imaging method that detects a target based on video images that are input from first imaging means and controls second imaging means to acquire tracking video images of the target, the automatic imaging apparatus main unit controls the second imaging means based on the position and size of a person appearing in the image that is input from the first imaging means.

Therefore, when tracking and imaging one person under imaging conditions in which a plurality of persons are detected in video images that are input from the first imaging means, using only the automatic imaging method according to the prior art has not been possible to extract the position and size of the single person that is to be actually imaged in the video images, and thus suitable tracking video images could not be obtained.

An object of the present invention is to obtain tracking video images even when a plurality of persons appear in video images input from first imaging means, by automatically selecting one person from among the plurality of persons and controlling second imaging means based on the position and size of that person in the video images.

A further object of the present invention is to enable tracking and imaging to be performed in accordance with a situation by making it possible to preset selection rules and appropriately reflect the selection operation in accordance with the importance in meaning of the imaging object.

An automatic imaging method according to this invention previously divides an imaging region of a video image to be acquired by first imaging means into a plurality of blocks, and for each block, estimates whether or not a part or all of a target (person or the like) to be tracked and imaged appears in the block, and regards a set of blocks in which the target is estimated to appear as pattern extraction results P (set of blocks P) that show the target or group of targets to be tracked and imaged, and examines a correlation (overlap) between the obtained pattern extraction results P and a prioritized region (referred to as “sense area”) that is previously set on an imaging region of a monitoring area to be imaged with the first imaging means in a form that is combined with a full view of the monitoring area, and extracts from connecting regions included in the pattern extraction results P a connecting region having a common portion with a sense area of highest priority among the connecting regions overlapping with sense areas, and takes that connecting region as a target for tracking and imaging, and furthermore, controls second imaging means based on a position and size of the target on the input video image to acquire tracking video images of a person corresponding to the target.

According to the automatic imaging method and automatic imaging apparatus of this invention, in a video monitoring system that shows on a monitor an enlarged video image of a target that was detected based on a video image of a monitoring area, even when a plurality of targets (persons or the like) to be tracked and imaged were extracted from video images of inside the monitoring area, one target can be determined from among those targets to enable tracking video images of the target to be obtained with second imaging means.

### BRIEF DESCRIPTION OF THE DRAWINGS

FIG. 1 is a view for explaining a method of extracting a significant pattern according to the automatic imaging method of this invention;

FIG. 2 is a view for explaining a method of selecting a target according to the automatic imaging method of this invention;

FIG. 3 is a block diagram of an automatic imaging apparatus according to a first embodiment of this invention;

FIG. 4 is an explanatory drawing of the automatic imaging method according to the first embodiment of this invention;

FIG. 5 is a block diagram of an automatic imaging apparatus according to a second embodiment of this invention;

FIG. 6 is a flowchart for explaining target candidate sense processing;

FIG. 7 shows explanatory drawings of new target determination processing;

FIG. 8 is an explanatory drawing of pattern update processing;

FIG. 9 is an explanatory drawing of target coordinates acquisition processing;

FIG. 10 is a view illustrating a method of calculating a tilt angle of second imaging means;

FIG. 11 is an explanatory drawing of a tracking method according to a third embodiment of this invention;

FIG. 12 shows views that illustrate an imaging method according to a fourth embodiment of this invention;

FIG. 13 is an explanatory drawing of first imaging means according to a fifth embodiment of this invention;

FIG. 14 is a block diagram of an automatic imaging apparatus according to a sixth embodiment of this invention;

FIG. 15 is a block diagram of an automatic imaging apparatus according to a seventh embodiment of this invention; and

FIG. 16 is an explanatory drawing of an automatic imaging method according to the prior art.

### BEST MODE FOR CARRYING OUT THE INVENTION

Hereunder, the automatic imaging method and automatic imaging apparatus according to the present invention are described with reference to the attached drawings.

The automatic imaging method according to this invention previously divides an imaging region of a video image (hereunder, referred to as “input video image I”) acquired with first imaging means 1 into a plurality of blocks, estimates for each block whether or not a part or all of a target (person or the like) to be tracked and imaged appears in the block, and regards a set of blocks in which the target is estimated to appear as pattern extraction results P (set of blocks P) that represent a target or group of targets to be tracked and imaged.

The automatic imaging method then examines the correlation (overlap) between the thus-obtained pattern extraction results P (set of blocks P) and N number of prioritized regions S (referred to as “sense areas”) that were preset on the imaging region of the monitoring area to be imaged by the first imaging means 1 in a form that is combined with a full view of the monitoring area, extracts a connecting region having a common portion with the sense area of highest priority from connecting regions included in the pattern extraction results P to take that connecting region as a target for tracking and imaging, and controls second imaging means 2 based on the position and size of the appearance of the target on the input video image to obtain tracking video images of the person corresponding to the target.

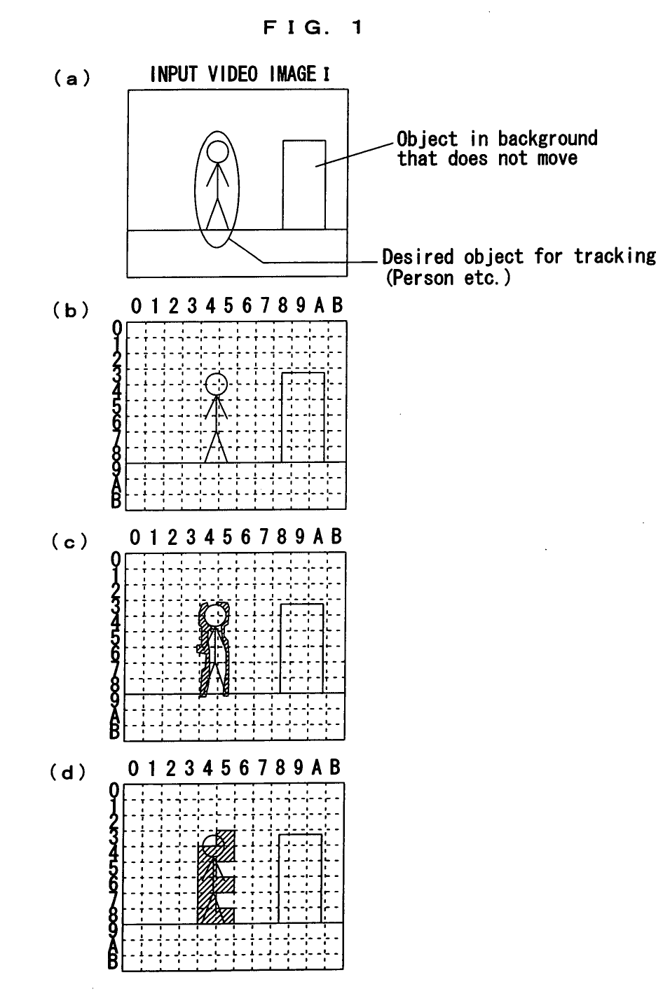

The procedure for extracting the pattern extraction results P (set of blocks P) that represent a target or group of targets to be tracked and imaged according to this invention will now be described with reference to FIG. 1.

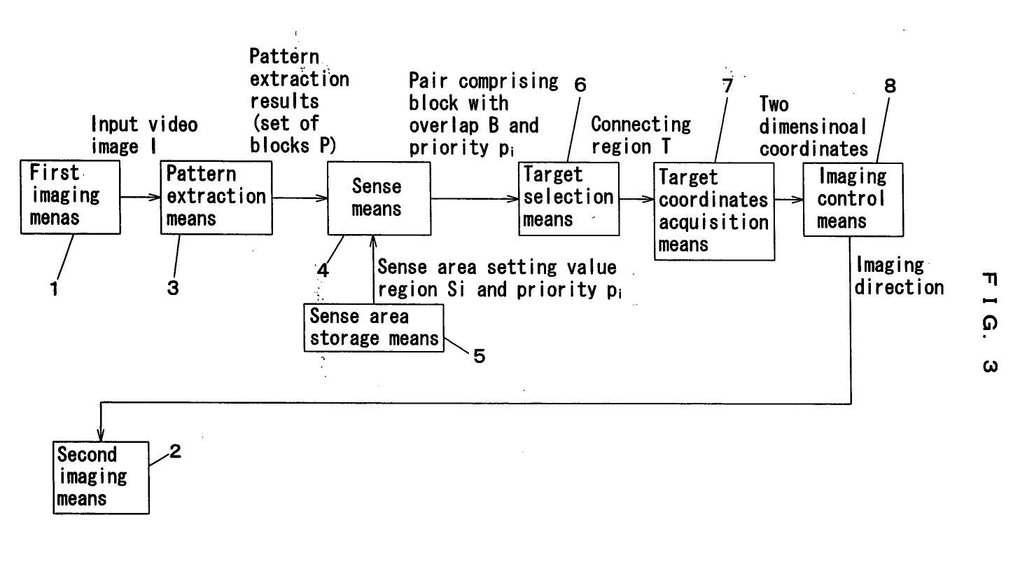

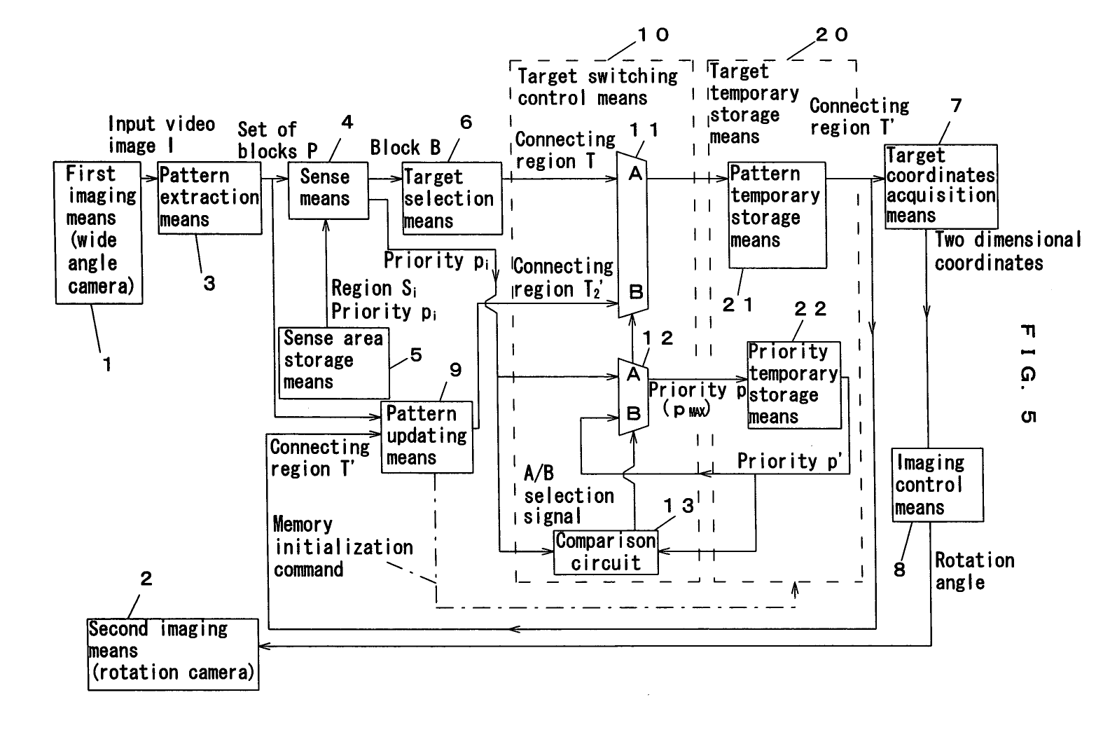

According to the automatic imaging method of this invention, in pattern extraction means 3, pattern extraction results P (set of blocks P) that represent a target or group of targets to be tracked and imaged are extracted on the basis of an input video image I that was input from the first imaging means 1 (refer to FIGS. 3 and 5).

In the embodiment illustrated in FIG. 1, after the input video image I shown in FIG. 1(a) is input, the imaging region of the input video image I is divided into a total of 114 blocks that consist of 12 vertical blocks×12 horizontal blocks as shown in FIG. 1(b). A plurality of pixels are included within a single block (pixel<block).

At the pattern extraction means 3, in order to extract a target or group of targets to be tracked and imaged, for each pixel in the input video image I the difference between an image captured before a time Δt and a current image is determined, and the difference is binarized by taking the absolute value thereof according to a threshold value T₁ (see FIG. 1(c)).

In a case where a person is moving in the input video image I shown in FIG. 1(a), when pixels for which movement was detected (pixels of “1”) are represented by slanting lines, a slanting line region appears as shown in FIG. 1(c). (The pixels in the slanting line region are output as “1”, other pixels are output as “0”.)

The pattern extraction means 3 counts the number of “1” pixels for each of the 114 blocks and binarizes the result according to a threshold value T₂, then estimates for each block whether or not a part or all of a target (person or the like) to be tracked and imaged appears in the block, and outputs a set P of blocks in which the target is estimated to appear (blocks of “1”) as pattern extraction results P.

That is, the pattern extraction means 3 outputs the set of blocks P with slanting lines as shown in FIG. 1(d) as the pattern extraction results P (significant pattern). (Blocks with slanting lines are output as “1”; other blocks are output as “0”.)

In FIG. 1(d), objects in the background that do not move (the floor or the door in the rear) are not extracted, and only the person that is the target that actually needs to be tracked and imaged is extracted.

If a plurality of persons are present in the input video image I and they are moving, only the plurality of persons that are moving are extracted, and they are output respectively as a set of blocks P.

In this connection, when extracting only a moving person based on the difference between the image captured before a time Δt and a current image, in some cases a person who is completely still cannot be extracted.

Accordingly, a person may be extracted from the input video image I, for example, by applying a background difference method to determine a difference between a previously stored background image and a current image.

Further, a method may also be applied that estimates whether a person is in a moving state or a still state and separates the processing depending on the state, as in Patent Document 1 that is disclosed above as prior art literature.

As described above, based on the input video image I that is input from the first imaging means 1, a group of persons and objects other than people (background and the like) can be distinguished by the pattern extraction means 3 to make it possible to extract as significant patterns, pattern extraction results P (set of blocks P) that represent a target or group of targets that are only a group of people to be tracked and imaged.

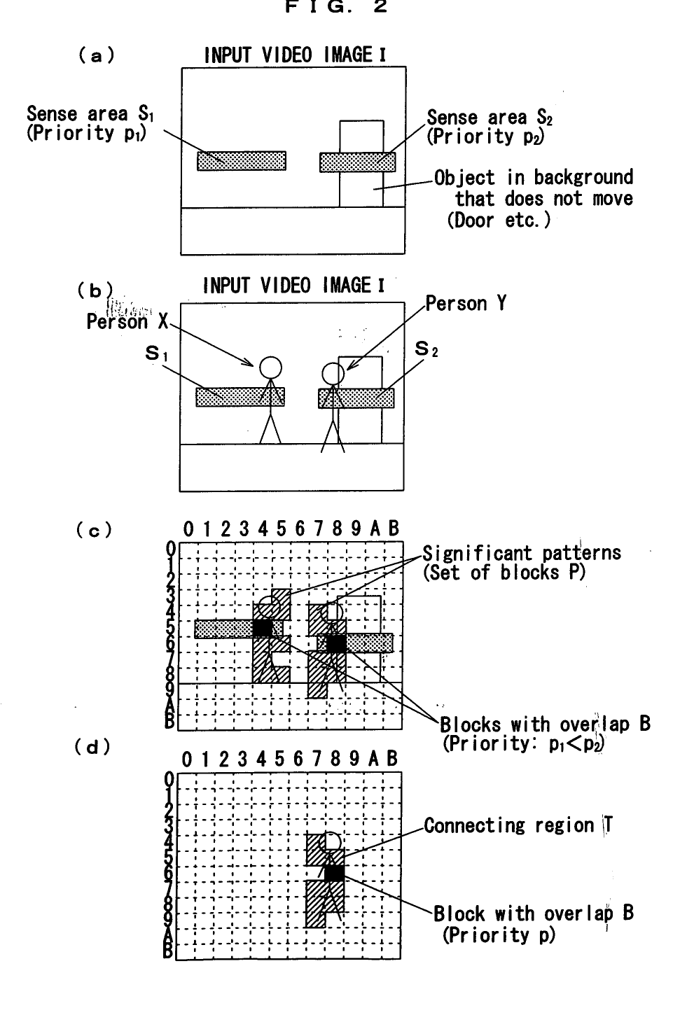

Next, a procedure for selecting one person as a person to be imaged from among a group of people extracted as pattern extraction results P (set of blocks P) will be described with reference to FIG. 2.

According to this invention, a sense area comprising N number of regions Sᵢ (i=1, 2, 3, . . . , N) of arbitrary shape that may contact with each other is previously set on the imaging region of the input video image I, and a priority pᵢ (i=1, 2, 3 . . . N) is also stored for each of the regions Sᵢ (i=1, 2, 3 . . . N) in sense area storage means 5 (see FIG. 3 and FIG. 5).

Next, overlapping with the pattern extraction results P (set of blocks P) that were output by the pattern extraction means 3 is determined for all of the regions Sᵢ by sense means 4, and when an overlap exists, a pair comprising a block B in which the overlap appeared and the priority pᵢ of the region Sᵢ in which the overlap appeared is output.

Thereafter, the pair with the highest priority (priority p) is selected by target selection means 6 from among pairs of block B and priority pᵢ that were output by the sense means 4, and a connecting region T that includes the block B is extracted from the set of blocks P output by the pattern extraction means 3, and output.

In the embodiment shown in FIG. 2, a group of people comprising a person X and a person Y appear in the input video image I as shown in FIG. 2(b). When movements in that input video image I are detected to extract pattern extraction results P (set of blocks P), as shown in FIG. 2(c), pattern extraction results P (set of blocks P) are extracted that include a plurality of connecting regions comprising a connecting region detected by movement of person X and a connecting region detected by movement of person X.

In this example it is assumed that, for example, sense areas S₁ and S₂ as shown in FIG. 2(a) are previously stored in the sense area storage means 5, and the respective priorities thereof are set as p₁=1, and p₂=2 (the priority of p₂ is higher than that of p₁).

At this time, if the sense area S₁ and the connecting region in which the movement of person X was detected overlap, and the sense area S₂ and the connecting region in which the movement of person Y was detected overlap as shown in FIG. 2(c), the sense means 4 outputs pairs consisting of the blocks B in which the overlaps occurred and the priorities (priorities p₁ and p₂) of the sense areas in which the overlaps occurred.

More specifically, the sense means 4 outputs the following information.

Regarding the correlation between person X and sense area S₁: <<overlapping block B=coordinates 4,5; priority p₁=1>>

Regarding the correlation between person Y and sense area S₂: <<overlapping block B=coordinates 8,6; priority p₂=2>>

In FIG. 2(c), the dotted regions represent sense area S₁ and sense area S₂, and the slanting line regions represent the connecting regions (pattern extraction results P) that were respectively detected by movement of person X and person Y. Further, in FIG. 2(c), the blacked out regions represent blocks B in which overlapping occurred between the sense areas S₁ and S₂ and the pattern extraction results P (set of blocks P).

Thus, the target selection means 6 selects the overlapping between sense area S₂ that has the highest priority and person Y (overlapping block B=coordinates 8,6; priority p₂=2), and extracts and outputs a connecting region T that includes the overlapping block B (coordinates 8,6) from the set of blocks P that were extracted as the pattern extraction results (target candidates).

As a result, a pattern represented by the slanting line region in FIG. 2(d) is output as the connecting region T. Thus, only the person Y is selected as an object (target) to be tracked and imaged by the second imaging means 2. That is, even when a group comprising more than one person (target candidate) is obtained as the pattern extraction results when patterns are extracted from the input video image I by movement detection or a background difference method or the like, it is possible to select a single person (target) from that group of people.

After selecting only person Y as the object to be tracked and imaged (target), by controlling the second imaging means 2 with imaging control means 8 so as to contain in the imaging field of view thereof the object (person Y) appearing in the region covered by the connecting region T on the input video image I, person Y is automatically tracked and imaged by the second imaging means 2.

In this connection, the N number of regions Sᵢ (i=1, 2, 3 . . . N) and their priorities pᵢ (i=1, 2, 3 . . . N) that are stored in the sense area storage means 5 are set in advance. That is, a rule for selecting one tracking object can be preset by setting prioritized sense areas beforehand.

Further, with respect to setting prioritized sense areas, since the position and shape of a sense area region Sᵢ and the priority pᵢ thereof can be arbitrarily set, by appropriately setting the priority and position of the region Sᵢ a selection operation can suitably reflect the importance in meaning of an imaging object so that a tracking object can be automatically imaged in accordance with the situation.

For example, in the situation shown in FIG. 2(a), when it is desired to extract the person Y that is in front of the door by priority over the person X that is in a different place, by setting a high priority for the sense area S₂ that is set in front of the door, the person Y in front of the door is extracted by priority as shown in FIG. 2(d) to allow tracking and imaging to be performed for person Y.

According to the above described imaging method, as long as target candidates (persons included in group of people) that were extracted as pattern extraction results P (set of blocks P) are moving, tracking and imaging of one person is automatically performed.

Further, by applying a background difference method as the pattern extraction means 3 to extract stationary people as the pattern extraction results P (set of blocks P), a stationary person can also be taken as an object of tracking and imaging.

Furthermore, by temporarily storing a connecting region T that was output from the target selection means 6 (connecting region T′), and comparing the current connecting region T and the past connecting region T′ that is stored, it is possible to determine whether a person in the tracking video images is moving or stationary. When it is determined that the person is stationary, the stationary person can be taken as an object for tracking and imaging by controlling the second imaging means 2 based on the past connecting region T′ that is stored, in place of the current connecting region T.

The aforementioned automatic imaging method remains in effect for a period in which the target candidates (people) that were extracted as pattern extraction results P (set of blocks P) overlap with sense areas (N number of regions Sᵢ (i=1, 2, 3 . . . N)) that are stored in the sense area storage means 5.

To continue tracking and imaging after a person has left a sense area (region Sᵢ), means is additionally provided for temporarily storing the connecting region T and priority p, as in the automatic imaging apparatus shown in FIG. 5.

In this case, there is provided priority-output attached target selection means 6 that selects a block B that overlaps with the sense area of highest priority (=priority p) from among pairs consisting of a block B having an overlap with a sense area (region Sᵢ) output by the sense means 4 and the priority of that sense area (priority Pᵢ), extracts a connecting region T including the block B from the set of blocks P output by the pattern extraction means 3, and outputs the connecting region T together with the priority p thereof; pattern temporary storage means 21 that temporarily stores the connecting region T output by the priority-output attached target selection means 6 and outputs it as connecting region T′; and priority temporary storage means 22 that, at the same time, temporarily stores the priority p that was output by the priority-output attached target selection means 6 and outputs it as a priority p′.

The second imaging means 2 is then controlled to contain the object (target) appearing in the region covered by the connecting region T′ on the input video image I in the field of view of the second imaging means 2, so that the image of the target is automatically imaged.

The connecting region T′ that is stored in the pattern temporary storage means 21 may be replaced with a connecting region T that was selected from the pattern extraction results P (current set of blocks P) that were extracted based on the current input video image I and the priority p′ stored in the priority temporary storage means 22 may be replaced with the priority p of the connecting region T only in a case in which the current priority p is greater than or equal to the priority p′.

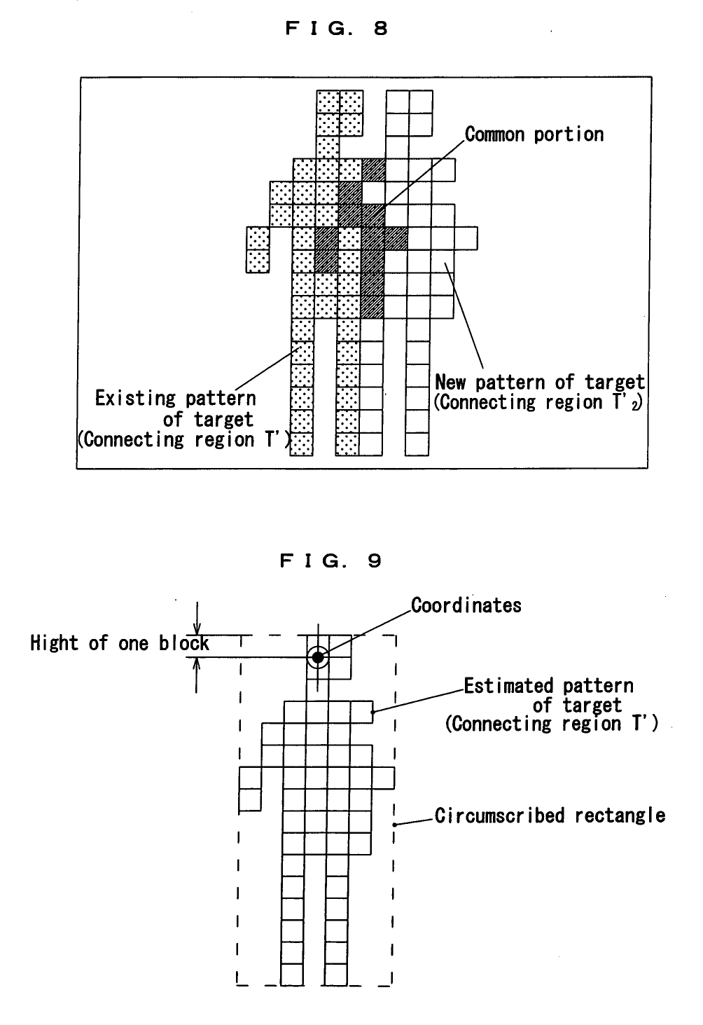

Further, for a period in which output of the sense means 4 is blank (period in which an overlapping block B does not exist), the connecting region T′ can be updated by extracting a connecting region T₂′ having an overlap with the connecting region T′ that is stored in the pattern temporary storage means 21 from the current set of blocks P output by the pattern extraction means 3, and newly storing this connecting region T₂′ in the pattern temporary storage means 21 (see FIG. 8).

In this connection, in FIG. 8 that illustrates updating of the connecting region T′, “existing pattern of target” in the figure corresponds to the connecting region T′ stored in the pattern temporary storage means 21, and “new pattern of target” is the connecting region T₂′ included in the current pattern extraction results P (current set of blocks P) extracted by the pattern extraction means 3 based on the current input video image I. Thus, the connecting region T′ can be updated by newly storing the “new pattern of target” (connecting region T₂′) in the pattern temporary storage means 21.

As a result, a person (target) that was selected for a time as connecting region T by the priority-output attached target selection means 6 and temporarily stored as connecting region T′ in the pattern temporary storage means 21 continues to be an object of tracking and imaging by the second imaging means 2 for a period until an overlap arises between a region Sᵢ having a higher priority than priority p′ of the connecting region T′ and the current pattern extraction results P (current set of blocks P) that were extracted based on the current input video image I.

Although in the foregoing description, the size of the blocks into which the imaging region of the input video image I was divided was taken as a total of 144 blocks comprising 12 vertical×12 horizontal blocks, the size of the blocks is not limited thereto. It is sufficient that the size of the blocks is decided bearing in mind the following items:

(1) Estimated ratio of correct results;

(2) Time and effort involved in examining correlation with sense areas;

(3) Separability (resolution) of target candidates; and

(4) Ease of tracking target movement.

For example, as an extreme case, when the size of each block is reduced until the size of a block=the size of a pixel, if noise exists in the single pixel the estimated result regarding whether a target appears in the relevant block may change and thus the estimated ratio of correct results (above-described item (1)) will be lowered. Further, since the total number of blocks will increase, the time and effort involved in examining the correlation with sense areas (above described item (2)) will increase.

Thus, from the viewpoint of optimizing the estimated ratio of correct results and the time and effort involved in examining the correlation with sense areas, it is desirable that blocks are large.

In contrast, when the blocks are enlarged to an extent that a plurality of target candidates can appear simultaneously within one block, a case may occur in which, although they do not contact and overlap, target candidates that are adjacent to each other cannot be separated on the aforementioned significant patterns and it is difficult to select either of the candidates as a target. More specifically, the separability/resolution of target candidates (above described item (3)) is reduced. Thus, from the viewpoint of optimizing the aforementioned separability (resolution) of target candidates, it is desirable that blocks are small.

Ease of tracking target movement (above-described item (4)) refers to, as shown in FIG. 8, the fact that an overlap between connecting regions T′ and T₂′ can be stably generated under normal target movement conditions. For example, in a case where the size of one block and the size of a target are substantially equal, when the target moves from one block to an adjoining block it is possible that an overlap will not be generated between connecting region T′ and connecting region T₂′. From this viewpoint it is desirable that the size of a block is smaller than the size of the appearance of a target on the input video image I so that the target is covered by a plurality of blocks.

### Embodiment 1

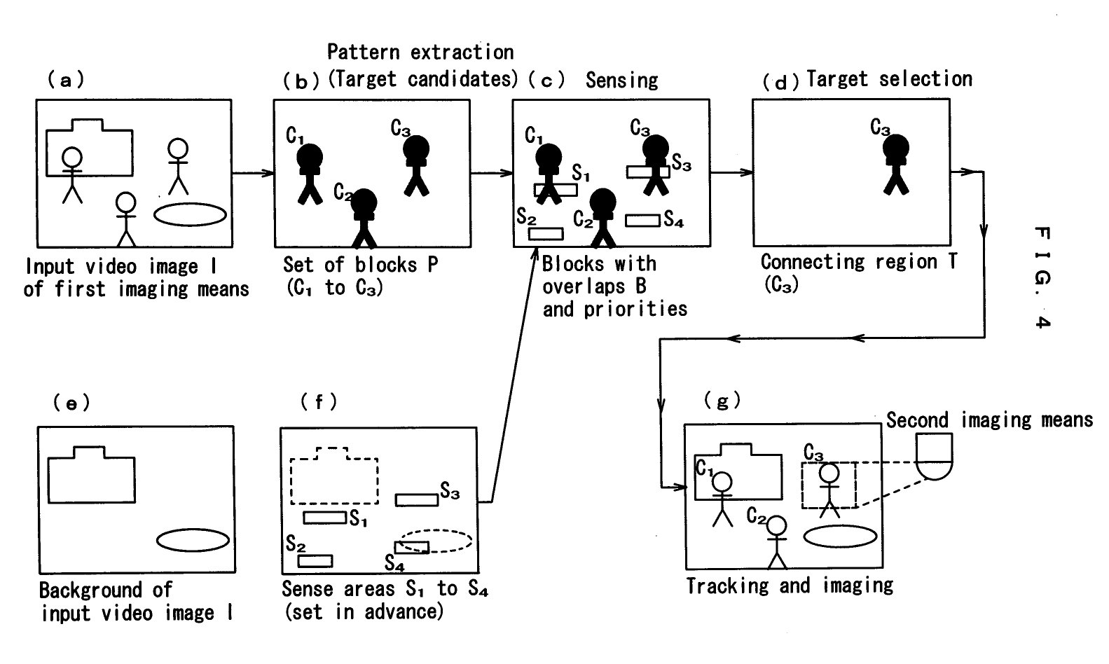

FIG. 3 and FIG. 4 are views that describe an automatic imaging method and automatic imaging apparatus according to a first embodiment of this invention.

In this embodiment, in a case where a plurality of connecting regions (hereunder, referred to as “patterns”) are extracted as pattern extraction results P (set of blocks P) when patterns were extracted from an input video image I acquired from the first imaging means 1, one pattern is selected as an imaging object from among the pattern extraction results P and imaged with the second imaging means 2.

That is, in a situation in which a plurality of significant patterns (target candidates) are present simultaneously within a region (entire monitoring region) imaged by the first imaging means 1 that comprises a wide angle camera, one candidate among the plurality of target candidates present within the monitoring region is automatically selected as a target, tracking and imaging is carried out for the target with the second imaging means 2 comprising pan, tilt, and zoom functions, and an enlarged image of the target that was imaged with the second imaging means 2 is shown on a monitor.

As means for automatically selecting one target from a plurality of target candidates, there is provided means that sets definite blocks (N number of regions Sᵢ (i=1, 2, 3 . . . N)) referred to as “sense areas” based on a video image of the entire monitoring region that was imaged by the first imaging means 1, and determines a single target from the detected plurality of target candidates by observing the correlation between the sense areas and the target candidates.

The method of setting a sense area is as follows. Based on a video image of a monitoring area imaged by the first imaging means 1, an operator sets arbitrary blocks (N number of regions Sᵢ (i=1, 2, 3 . . . N)) using sense area setting means, and also sets priorities (priority pᵢ (i=1, 2, 3 . . . N)) for those blocks. For example, a video image of the entire monitoring region that was imaged by the first imaging means is displayed on a monitor, and based on that image the operator sets sense areas on the video image of the monitoring area.

A configuration may also be adopted in which means is provided for changing the setting conditions (information regarding position, range, and priorities) of sense areas that were previously set, to enable the settings for the sense areas to be changed by an instruction from the means. Further, means may also be provided that makes it possible to temporarily disable an arbitrary sense area among a group of previously set sense areas.

As shown in FIG. 3, the automatic imaging apparatus according to the first embodiment includes first imaging means 1 comprising a wide angle camera that images an entire monitoring region, and second imaging means 2 comprising a rotation camera that tracks and images a target that was detected on the basis of a video image imaged with the first imaging means 1.

The first imaging means 1 is a camera based on perspective projection, that determines coordinates (positions) within an imaged video image by employing the image center as the position of the optical axis of the lens, by taking the leftward direction as the normal direction of the X axis and the upward direction as the normal direction of the Y axis, with the image center as a point of origin. Further, the direction away from the camera (first imaging means 1) along the optical axis is taken as the normal direction of the Z axis.

The second imaging means 2 is a rotation camera equipped with pan, tilt, and zoom functions, that is disposed adjacent to the first imaging means 1 and provided such that the plane of pan rotation becomes parallel with the optical axis of the first imaging means 1 (wide angle camera), so that the plane of pan rotation is parallel with respect to a horizontal line of a video image imaged by the first imaging means 1.

The automatic imaging apparatus according to this invention further includes pattern extraction means 3 that extracts pattern extraction results P (set of blocks P) by subjecting video images captured by the first imaging means 1 to movement detection processing, acquires information regarding the position and range of target candidates based on this pattern extraction result, and outputs the information as patterns (connecting regions) of target candidates; sense area storage means 5 that stores sense area information comprising N number of regions Sᵢ (i=1, 2, 3 . . . N)) (information comprising setting positions and ranges) that are previously set within the monitoring area as sense areas by the operator based on a video image of the entire monitoring region as well as a priority pᵢ (i=1, 2, 3 . . . N) of each region; sense means 4 that examines the correlation between sense areas and target candidates based on the sense area information and the pattern extraction results; and target selection means 6 that determines a target by outputting the pattern of a target candidate having a common portion (overlapping block B) with a sense area having the highest priority based on the correlation as the estimated pattern of a new target.

The pattern extraction means 3 according to this embodiment performs movement detection processing based on video images (video images of the entire monitoring region) that were imaged by the first imaging means 1, determines a difference between an image of a frame at a time t constituting the video images and a previously stored background image of the entire monitoring region, and outputs the pattern of a portion (block) in which a significant difference was detected as a pattern extraction result to thereby acquire patterns of target candidates.

In this connection, for detecting target candidates by movement detection processing, a configuration may also be adopted in which a difference between a frame image at time t and an image of a frame at a time t-1 is determined, and the pattern of a portion (block) in which a significant difference was detected is output as a pattern extraction result.

As a pattern extraction method using the pattern extraction means 3, a significant pattern may also be extracted based on a judgment regarding a brightness difference, temperature difference, hue difference, a specific shape or the like, and not a method (movement detection processing) that detects a significant pattern based on a background difference or the presence or absence of movement.

For example, the temperature of the entire imaging region can be sensed by a temperature sensing process based on video images captured by the first imaging means 1, and patterns of portions with a high temperature can be extracted and output as pattern extraction results to thereby acquire patterns of target candidates.

The sense area storage means 5 respectively stores sense area information comprising N number of regions Sᵢ (i=1, 2, 3 . . . N)) (information comprising setting positions and ranges) and the priority pᵢ (i=1, 2, 3 . . . N) of each region that are previously set as sense areas by the operator based on video images of the entire monitoring region that were imaged by the first imaging means.

For example, when four sense areas S₁ to S₄ were set, the sense area storage means 5 stores sense area information comprising pairs of each of the regions S₁ to S₄ (information comprising setting positions and ranges) and the priorities p₁ to p₄ of each region.

The sense area information that is stored in the sense area storage means 5 and the pattern extraction results that are output from the pattern extraction means 3 are input into the sense means 4. The sense means 4 examines the correlation between the pattern extraction results and the sense areas to determine the sense area with the highest priority among the sense areas having a correlation (having a common portion) with the pattern extraction results (patterns of target candidates), and outputs the pattern (overlapping block B) of a common portion between the pattern extraction results (patterns of target candidates) and the region (information comprising setting position and range) of the sense area in question, and the priority (priority p) of the sense area in question.

Based on information output from the sense means 4, the target selection means 6 determines the pattern of a target candidate having a common portion with the sense area of higher priority among the pattern extraction results (patterns of target candidates) output by the pattern extraction means 3, and outputs this pattern as the estimated pattern of a new target to be input to target position acquisition means 7. More specifically, the target to be tracked and imaged by the second imaging means 2 is determined in the target selection means 6.

When there is a plurality of patterns of target candidates having a common portion with the sense area of higher priority, priorities are assigned within the sense area such that a pattern having a common portion that has the higher priority within the sense area is output as the estimated pattern of a new target (connecting region T).

This automatic imaging apparatus further comprises target position acquisition means 7 that acquires the positional coordinates of an estimated pattern of a new target (connecting region T) that is input from the target selection means 6, and imaging control means 8 that determines the imaging direction of the second imaging means 2 based on the positional coordinates of the target. By means of the second imaging means 2 the apparatus performs tacking imaging of a target selected based on video images that were imaged with the first imaging means 1, to thus acquire tracking video images of the target.

Next, an automatic imaging method according to this embodiment will be described with reference to FIG. 4.

The embodiment shown in FIG. 4 determines a single target (person) based on an overall video image of a monitoring area that is input from the first imaging means 1 under monitoring conditions in which three persons are present within the monitoring area, and acquires tracking video images of this target with the second imaging means 2.

The automatic imaging method according to this embodiment comprises a first step of imaging the entire monitoring region with the first imaging means 1 to acquire an overall video image of the monitoring area (see FIG. 4(a)); a second step of extracting only significant patterns (patterns of target candidates) from the overall video image of the monitoring area by pattern extraction processing (see FIG. 4(b)); a third step of examining the correlation between pattern extraction results and sense areas (see FIG. 4(c)); a fourth step of deciding on the pattern (pattern of target candidate) having a common portion with the sense area of higher priority as the target (FIG. 4(d)); and a fifth step of controlling the imaging direction of the second imaging means 2 based on the position of this target to perform tracking and imaging of the target with the second imaging means (FIG. 4(g)).

First Step:

The background of the imaging region and the persons (target candidates) present within the monitoring area appear in overall video images of the monitoring area that are input from the first imaging means 1 (see FIG. 4(a)).

Second Step:

Significant patterns (target candidates) are extracted based on differences between the overall video image of the monitoring area that is input from the first imaging means 1 (FIG. 4(a)) and previously acquired background video images (FIG. 4(e)) of the monitoring area (see FIG. 4(b)). More specifically, the pattern extraction means 3 extracts significant patterns from the overall video image of the monitoring area that is input from the first imaging means 1, to acquire pattern extraction results P.

In this embodiment, the video imaging regions of three persons present within the monitoring area are extracted as significant patterns (target candidates) C₁ to C₃ from the overall video image, to thereby acquire pattern extraction results P (set of blocks P) for which only the significant patterns (target candidates) C₁ to C₃ were extracted (see FIG. 4(b)).

Third Step:

The correlation (existence or non-existence of a common portion) between the pattern extraction results P and the sense areas is examined by the sense means 4.

The sense areas are previously set within the monitoring area (on the video image) by the operator on the basis of the overall video image of the monitoring area that is input from the first imaging means 1 (see FIG. 4(f)). In this embodiment four sense areas S₁ to S₄ are set, and the priority of each sense area is set such that sense area S₁<sense area S₂<sense area S₃<sense area S₄. Sense area information comprising the four regions S₁ to S₄ (information including setting position and range) set as sense areas S₁ to S₄ and the priorities p₁ to p₄ of these regions is stored in the sense area storage means 5.

The sense area information (FIG. 4(f)) that is stored in the sense area storage means 5 and the pattern extraction results P (FIG. 2(b)) extracted by the pattern extraction means 3 are then input into the sense means 4 to examine the correlation between the sense areas and the pattern extraction results P (target candidates) (see FIG. 4(c)). According to the embodiment, as shown in FIG. 4(c), the sense area S₁ and the pattern (target candidate) C₁, and the sense area S₃ and the pattern (target candidate) C₃ correspond, respectively (have common portions).

Fourth Step:

The sense means 4 determines the sense area with the highest priority among the sense areas having a common portion with a significant pattern (target candidate) by examining the correlation between the sense areas and the pattern extraction results P, and selects the pattern (target candidate) having a common portion with this sense area to decide the target.

According to this embodiment, since the priorities of the sense areas are set such that S₃>S₁, the pattern (target candidate) C₃ having a common portion with the sense area S₃ is determined as the target (see FIG. 4(d)).

Fifth Step:

The imaging direction of the second imaging means is controlled based on the position of the target (pattern C₃) in the overall video image of the monitoring area that was input from the first imaging means 1, so that the target (pattern C₃) is imaged by the second imaging means 2.

That is, the swivel direction of the second imaging means 2 comprising a rotation camera equipped with pan, tilt, and zoom functions is designated based on the position of the target (pattern C₃) in the overall video image, such that tracking and imaging of a person corresponding to the pattern C₃ is performed by the second imaging means 2 (see FIG. 4(g)).

By repeating the above first to fifth steps, it is possible to automatically select a single target in an environment in which a plurality of target candidates are present within a monitoring area imaged by the first imaging means 1, and to perform tracking and imaging of the target with the second imaging means 2 that is equipped with pan, tilt, and zoom functions.

According to the automatic imaging method shown in FIG. 4, until either one of the following conditions (1) and (2) is realized, the pattern C₃ is automatically selected as a target and tracking and imaging of this target (person corresponding to pattern C₃) is performed by the second imaging means 2: (1) the selected target (pattern C₃) leaves the sense area S₃ (the selected target no longer has a correlation with the sense area); or (2) a pattern having a correlation with a sense area that has a higher priority (in this embodiment, sense area S₄) than the sense are a S₃ (target priority) having a correlation with the target (pattern C₃) being tracked by the second imaging means is present in current pattern extraction results P output by the pattern extraction means (a pattern emerges that has a correlation with a sense area of higher priority).

In this connection, by providing means that controls the direction of imaging by the second imaging means 2 preferentially from outside, not only can the image of a target selected by the automatic imaging method according to this invention be displayed on a monitor, but it is also possible to display on a monitor a target that was imaged by the second imaging means 2 based on the instructions of an operator.

Further, a configuration may be adopted whereby when a target candidate having a correlation with a sense area is not detected upon examining the correlation between sense area information and pattern extraction results (target candidates), imaging is performed such that the second imaging means 2 is zoomed out by regarding the situation as one in which there is no target to be imaged, or is operated under preset swivel conditions to perform imaging by automatic panning, or to image a preset imaging block (home position) at a preset zoom ratio.

Furthermore, upon investigating the correlation between the sense area information and the pattern extraction results (target candidates), information regarding the existence or non-existence (state) of a common portion between sense areas and target candidates, information regarding the imaging method (kind of imaging) performed by the second imaging means 2, or information regarding whether a target displayed on a monitor has a common portion with any sense area may be output.

Not only can tracking video images of a target be displayed on the monitor, but by outputting information regarding the existence or non-existence of a common portion between sense areas and target candidates, it is possible for an external apparatus that is connected to an automatic imaging apparatus based on this invention to easily ascertain whether or not a significant pattern (target candidate) having a correlation with a sense area appeared. For example, if the aforementioned external apparatus is an image recording apparatus, control of image recording (start/stop of recording) or the like can be performed based on that information (existence or non-existence of a common portion between sense areas and target candidates). Also, for example, when video images displayed on a monitor are tracking images of a target, the apparatus can output that the images are tracking images, when video images displayed on a monitor are video images obtained by automatic panning, the apparatus can output that the images are automatic panning video images, so that by outputting the kind of video images being displayed on the monitor in this manner it will be easy to ascertain the kind of video images being displayed on a monitor. Furthermore, for example, by outputting information regarding whether a target displayed on a monitor has a common portion with any sense area, the position of the target displayed on the monitor can be easily ascertained.

Thus, when monitoring (performing video image monitoring) a monitoring area by operating a plurality of automatic imaging apparatuses based on this invention or the like, a method of utilization may also be applied whereby only video images of an imaging apparatus performing the most important imaging based on information ascertained as described above are selected and output by an external apparatus (video image switching apparatus) that selects video images to be displayed on a monitor.

### Embodiment 2

Next, an automatic imaging method and automatic imaging apparatus according to a second embodiment will be described with reference to FIG. 5 and FIGS. 6 to 10.

The automatic imaging method according to the second embodiment is a method that automatically selects a single target using the correlation between pattern extraction results and sense areas in a situation in which a plurality of significant patterns (target candidates) are simultaneously present in a region (entire monitoring region) imaged with first imaging means 1 comprising a wide angle camera, and acquires tracking video images of that target by performing tracking and imaging of the target with second imaging means 2 comprising pan, tilt and zoom functions, wherein means is provided for continuing tracking and imaging of the target that is being imaged by the second imaging means 2 even if the target moves outside a sense area.

Further, as shown in FIG. 5, the automatic imaging apparatus according to the second embodiment comprises first imaging means 1 that images an entire monitoring region; second imaging means 2 that can change the direction of the imaging field of view; pattern extraction means 3 that, for each block formed by dividing an imaging region of an input video image I that was input from the first imaging means 1, estimates whether or not a part or all of an object to be tracked and imaged appears in the respective block, and outputs as significant patterns a set of blocks P in which a part or all of the object is estimated to appear; sense area storage means 5 that stores sense areas comprising N number of regions Sᵢ (i=1, 2, 3 . . . N) of arbitrary shape that were previously set on the imaging region of the input video image I together with the priority pᵢ (i=1, 2, 3 . . . N) of each region; sense means 4 that for all the regions Sᵢ, determines whether an overlap exists with the set of blocks P output by the pattern extraction means 3, and when overlap exists, outputs a pair consisting of a block B in which an overlap appeared and the priority pᵢ of the overlapped sense area Sᵢ; target selection means 6 that selects the pair with the highest priority (priority p) among the pairs of overlapping block B and the priority pᵢ thereof that were output by the sense means 4, and extracts a connecting region T that includes the block B in question from the set of blocks P; pattern temporary storage means 21 that temporarily stores the connecting region T and outputs it as a connecting region T′; priority temporary storage means 22 that temporarily stores the priority p and outputs it as a priority p′; and imaging control means 8 that controls the second imaging means 2 so as to contain in the imaging field of view an object (target) appearing in the region covered by the connecting region T′ on the input video image I.

The connecting region T′ that is temporarily stored is replaced with a connecting region T that was selected from a current set of blocks P that were extracted based on a current input video image I, and the priority p′ that is temporarily stored is replaced with a priority p that was obtained together with the connecting region T only in a case where the current priority p is greater than or equal to the priority p′. Further, for a period in which a connecting region T to be temporarily stored is not detected and the connecting region T is thus blank, a connecting region T₂′ that has an overlap with the temporarily stored connecting region T′ is extracted from the current set of blocks P extracted from the current input video image I to update the connecting region T′ with the connecting region T₂′.

As shown in FIG. 5, similarly to the automatic imaging apparatus of the first embodiment, the automatic imaging apparatus according to this embodiment includes first imaging means 1 comprising a wide angle camera that images an entire monitoring region; second imaging means 2 comprising a rotation camera that performs tracking and imaging of a target that was selected on the basis of video images imaged with the first imaging means 1; pattern extraction means 3 that outputs pattern extraction results (patterns of target candidates) based on video images imaged with the first imaging means 1; sense area storage means 5 that stores sense area information; sense means 4 that examines the correlation between the sense area information and the pattern extraction results; and target selection means 6 that outputs the pattern of a target candidate having a common portion with the sense area of higher priority as the estimated pattern of a new target.

The automatic imaging apparatus according to this embodiment further includes target position acquisition means 7 that acquires positional coordinates of a target; and imaging control means 8 that determines the imaging direction of the second imaging means 2 based on the positional coordinates of the target.

The first imaging means 1 is a camera that is based on perspective projection, that determines coordinates (positions) within an imaged video image by employing the image center as the position of the optical axis of the lens, by taking the leftward direction as the normal direction of the X axis and the upward direction as the normal direction of the Y axis, with the image center as the point of origin. Further, the direction away from the camera (first imaging means 1) along the optical axis is taken as the normal direction of the Z axis.

The second imaging means 2 is a rotation camera equipped with pan, tilt, and zoom functions, that is disposed adjacent to the first imaging means 1 and provided such that the plane of pan rotation becomes parallel with the optical axis of the first imaging means 1 (wide angle camera), so that the plane of pan rotation is parallel with respect to a horizontal line of a video image imaged by the first imaging means 1.

The pattern extraction means 3 performs movement detection processing based on video images (video images of the entire monitoring region) that were imaged by the first imaging means 1, determines a difference between an image of a frame at a time t constituting the video images and a previously stored background image of the entire monitoring region, and outputs the pattern of a portion in which a significant difference was detected as a pattern extraction result to thereby acquire a pattern of a target candidate.

As a pattern extraction method, a method that determines a difference between a frame image at time t and an image of a frame at a time t-1 and extracts the pattern of a portion in which a significant difference was detected, or a method that extracts a significant pattern by determining a brightness difference, a temperature difference, a hue difference, whether a pattern is a specific shape or not, or the like may be used.

The sense area storage means 5 respectively stores sense area information comprising N number of regions Sᵢ (i=1, 2, 3 . . . N)) (information comprising setting positions and ranges) that are previously set as sense areas by the operator based on video images of the entire monitoring region that were imaged by the first imaging means, as well as the priority pᵢ (i=1, 2, 3 . . . N) of each region.

For example, when four sense areas S₁ to S₄ were set, the sense area storage means 5 stores sense area information comprising pairs of one of the sense area regions S₁ to S₄ (information comprising setting positions and ranges) and the respective priority p₁ to p₄ of each region.

The sense area information (region S₁ and priority p₁) that is stored in the sense area storage means 5 and the pattern extraction results that were output from the pattern extraction means 3 are input into the sense means 4. The sense means 4 examines the correlation between the pattern extraction results and the sense areas to determine the sense area with the highest priority among the sense areas having a correlation (having a common portion) with the pattern extraction results (patterns of target candidates), and outputs the pattern of a common portion between the pattern extraction results (patterns of target candidates) and the region S₁ (information comprising setting position and range) of the sense area in question, and the priority (priority p) of the sense area in question.

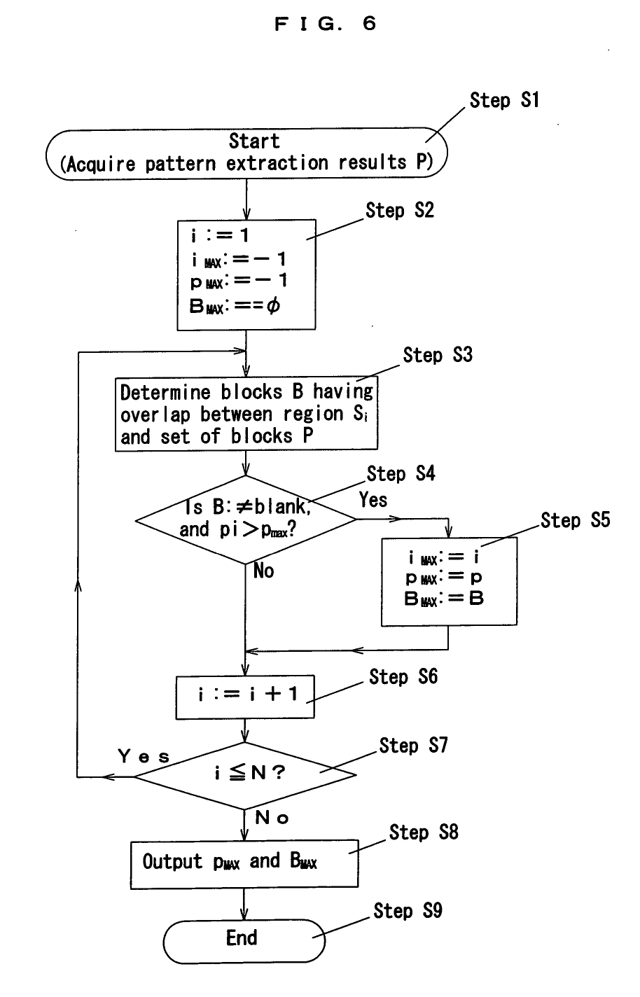

Target candidate sense processing according to this embodiment will now be described with reference to the flowchart shown in FIG. 6.

According to this embodiment, upon inputting the pattern extraction results P (patterns of target candidates) that were output from the pattern extraction means 3 into the sense means 4, target candidate sense processing begins (step S1), whereby the correlation with the target candidates is examined sequentially for each sense area based on the pattern extraction results P and sense area information (for example, sense area information for sense areas S₁ to S₄) that was input from the sense area storage means 5.

In the flowchart shown in FIG. 6, regions (information comprising setting position and range) that were set as sense areas are represented as Sᵢ (i=1, 2, 3 . . . N) and priorities are represented as pᵢ (i=1, 2, 3 . . . N). Further, the priority of a sense area S_{MAX} having a common portion with pattern extraction results P (patterns of target candidates) is represented as p_{MAX}, and the pattern of a common portion between the pattern extraction results P and the sense area S_{MAX} is represented as B_{MAX}.

The values i_{MAX}=−1, p_{MAX}=−1, and B_{MAX}=φ are respectively set as initial values, and target candidate sense processing is performed in order from sense areas S₁ to S₄ for each sense area region Sᵢ that is set on the video image of the monitoring area (step S2).

In this connection, a value (“−1”) that is lower than the priority of any sense area is set as the initial value for the priority of the sense areas.

First, “1” is set for the value of i (i=1), and a common portion B (overlapping block B) between the pattern extraction results P and the sense area Sᵢ is determined (step S3). More specifically, the correlation (existence or non-existence of common portion) between the sense area Sᵢ (region Sᵢ) and the pattern extraction results P is examined.

Next, the priority p₁ of the sense area S₁ and the common portion B with the pattern extraction results are determined (step S4), and if the common portion B is not blank and the priority p₁ of the sense area S₁ is greater than the priority p_{MAX} (initial value: p_{MAX}=−1) of the sense area that is already set (Yes), the priority p₁ of the sense area S₁ and the pattern B (overlapping block B) of the common portion with the pattern extraction results P are respectively updated (set and registered) as the priority p_{MAX} of the sense area S_{MAX} having a common portion with pattern extraction results P (patterns of target candidates) and the pattern B_{MAX} of the common portion with the pattern extraction results P (patterns of target candidates) (step S5). Thereafter, the value for i is incremented by “1” (step S6), and the correlation between the target candidates and the sense area is examined for sense area S₂ (step S3 to S5).

In contrast, when the priority p₁ of the sense area S₁ and the common portion B with the pattern extraction results are determined (step S4), and the conditions that the common portion B is not blank and the priority p₁ of the sense area S₁ is greater than the priority p_{MAX} (initial value: p_{MAX}=−1) of the sense area that is already set are not satisfied (No), the value of i is immediately incremented by “1” (step S6) and the correlation between the target candidates and the sense area is examined for sense area S₂ (steps S3 to S5).

After repeating steps S3 to S6 to examine the correlation with the pattern extraction results P (target candidates) for all the sense areas (sense areas S₁ to S₄) in order from sense area S₁ (step S7), the priority p_{MAX} of the sense area with the highest priority among the sense areas having a common portion with the pattern extraction results P, and a pattern B_{MAX} of a common portion between the pattern extraction results P and the relevant sense area are output (step S8), the target candidate sense processing ends (step S9), and the sense means 4 waits for the next input of pattern extraction results P.

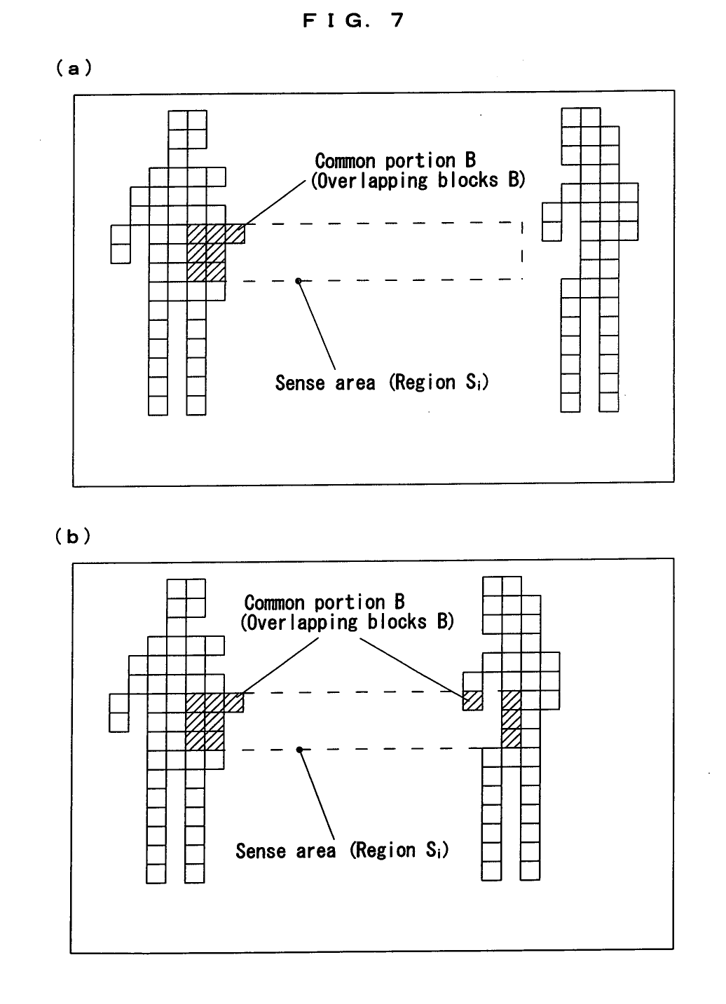

Based on information output from the sense means 4, the target selection means 6 determines the pattern of a target candidate having a common portion with the sense area of higher priority among the pattern extraction results (patterns of target candidates) output by the pattern extraction means 3, and outputs this pattern as the estimated pattern of a new target (see FIG. 7).

In this embodiment, the estimated pattern of a new target that was output by the target selection means 6 is input to target switching control means 10.

Processing to determine a new target by the target selection means 6 will now be described with reference to FIG. 7.

As shown in FIG. 7(a), the pattern of the target candidate having a common portion with the sense area S_{MAX} of higher priority is determined.

As shown in FIG. 7(b), when there is a plurality of target candidates having a common portion with the sense area S_{MAX} of higher priority, only one target candidate is selected by applying an appropriate rule.

For example, the target candidate whose common portion between the sense area and the target candidate's patterns is furthest on the upper left side is preferentially selected.

The tracking and imaging apparatus according to this embodiment further comprises means (pattern updating means 9) for updating (renewing) the target in question to continue imaging even when the target that is tracked and imaged by the second imaging means 2 leaves the sense area; and means (target information temporary storage means 20) that stores a pair consisting of the priority (hereunder, referred to as “target priority”) of the sense area having a correlation with the target the second imaging means 2 is tracking and the pattern of the target, wherein the second imaging means 2 continues tracking and imaging of the target until conditions are realized in which a correlation occurs with a pattern in a sense area having a priority that is higher than the target priority stored in the target information temporary storage means 20.

In this connection, a configuration may also be adopted whereby the second imaging means 2 continues tracking and imaging of the target until conditions are realized in which a correlation occurs with a pattern in a sense area having a priority that is greater than or equal to the target priority stored in the target information temporary storage means 20.

That is, by comparing the priority of a sense area having a correlation with pattern extraction results that were extracted on the basis of video images output in order from the first imaging means 1 with the target priority stored in the target information temporary storage means 20, and determining an estimated pattern of an updated target that is output from the pattern updating means 9 as the target until a pattern appears that has a correlation with a sense area having a priority that is higher than the target priority or is greater than or equal to the target priority, the target is updated (continued) and imaged even after the target being imaged by the second imaging means 2 leaves the sense area.

In contrast, when a pattern appeared that has a correlation with a sense area having a priority that is higher than the target priority or is greater than or equal to the target priority, the target to be tracked by the second imaging means 2 is switched, the target candidate having a correlation with a sense area of higher priority among the target candidates acquired based on video images input from the first imaging means 1 is determined as the target, and tracking and imaging of the newly acquired target is performed.

The pattern of the target being tracked and imaged by the second imaging means 2 (estimated pattern of target) and the pattern extraction results (patterns of target candidates) extracted by performing pattern extraction processing based on video images that were newly input from the first imaging means 1 are input into the pattern updating means 9, and a connecting region (new pattern of target) that includes a common portion with a pattern (existing pattern of target) of the target being tracked and imaged by the second imaging means 2 is acquired and output as the estimated pattern of the updated target.

When a connecting region (new pattern of target) that includes a common portion with a pattern (existing pattern of target) of the target being tracked and imaged by the second imaging means 2 does not exist, the estimated pattern of target (existing pattern of target) that was input is output in that state as the estimated pattern of the updated target.

When a state in which the aforementioned connecting region (new pattern of target) does not exist continues for a preset period (T_{HOLD} seconds), a target information clear command is output once.

The estimated pattern of the updated target that was output from the pattern updating means 9 is input into the target switching control means 10.

Further, the target information clear command is input into the target information temporary storage means 20, whereupon tracking of the target that was being imaged by the second imaging means 2 ends.

The pattern update processing that is performed by the pattern updating means 9 will now be described with reference to FIG. 8.

As shown in FIG. 8, a connecting region (new pattern of target (connecting region T₂′)) that includes a common portion with the pattern of the target that is being tracked and imaged by the second imaging means 2 (existing pattern of target (connecting region T′)) is acquired from pattern extraction results that were extracted by pattern extraction processing that was performed based on video images newly input from the first imaging means 1.

When two or more connecting regions that include a common portion with the pattern (existing pattern of target) of the target that is being tracked and imaged by the second imaging means 2 exist in the pattern extraction results, for example, preference is given to the pattern for which the common portion is further to the left upper side, and the connecting region including that common portion (common portion that is further to the left upper side) is acquired as the new pattern of the target.

Into the target switching control means 10 are input the estimated pattern of the new target (connecting region T) that is output from the target selection means 6, the priority (priority p (p_{MAX})) of the sense area that has a correlation with the estimated pattern of the new target that is output from the sense means 4, the estimated pattern of the updated target (connecting region T₂′) that is output from pattern update means 9, and the target priority (priority p′) that is stored in the target information temporary storage means 20 (priority temporary storage means 22).

The target switching control means 10 comprises comparison circuit 13 that compares the priority of a sense area and the target priority, a second selector 12 that selects either one of the priorities that were compared by the comparison circuit 13, and a first selector 11 that selects a pattern that forms a pair with the priority selected by the second selector 12 from among the estimated pattern of the new target and estimated pattern of the updated target. During a period until a pattern (estimated pattern of new target) having a correlation with a sense area that has a priority that is higher than the target priority or greater than or equal to the target priority is input, the estimated pattern of the updated target is output as the estimated pattern of the target and the target priority that was input is output as it is as the target priority.

In contrast, when a pattern is input that has a correlation with a sense area having a priority that is higher than the target priority or is greater than or equal to the target priority, the estimated pattern of the new target is output as the estimated pattern of target and the priority of the sense area that was input is output as the target priority.

The estimated pattern of target and target priority that were output from the target switching control means 10 are input into the target information temporary storage means 20 and stored in the target information temporary storage means 20.

The target information temporary storage means 20 comprises pattern temporary storage means 21 that temporarily stores the pattern of the target to be tracked and imaged by the second imaging means, and priority temporary storage means 22 that temporarily stores the target priority of the target in question.

When a target information clear command is input into the target information temporary storage means 20, the estimated pattern of the target that is stored in the pattern temporary storage means 21 is cleared and the target priority stored in the priority temporary storage means 22 is set to the initial value (“−1”). The initial value of the target priority is a value that is lower than the priority of any sense area.

The automatic imaging apparatus according to this embodiment further comprises target position acquisition means 7 that acquires positional coordinates of the estimated pattern of the target, and imaging control means 8 that determines the imaging direction of the second imaging means 2 based on the positional coordinates of the target, wherein the second imaging means 2 performs tracking and imaging for a target that was selected based on video images imaged by the first imaging means 1.

Target coordinates acquisition processing performed by the target position acquisition means 7 will now be described with reference to FIG. 9.

Based on the estimated pattern of the target (pattern of target) stored in the target information temporary storage means 20, the target position acquisition means 7 determines the position (coordinates (x, y) of a point R) of the pattern in question on a video image input from the first imaging means 1.

In this embodiment, the coordinates of the upper center (amount of one block down from upper edge) of the circumscribed rectangle of the estimated pattern of the target (pattern of target) are output to determine the position (coordinates (x, y) of point R) of the target on the video image acquired by the first imaging means 1.

Subsequently, the imaging control means 11 determines the direction that the second imaging means 2 should point towards (imaging direction) based on the coordinates (positional information) output by the target coordinates acquisition means 7.

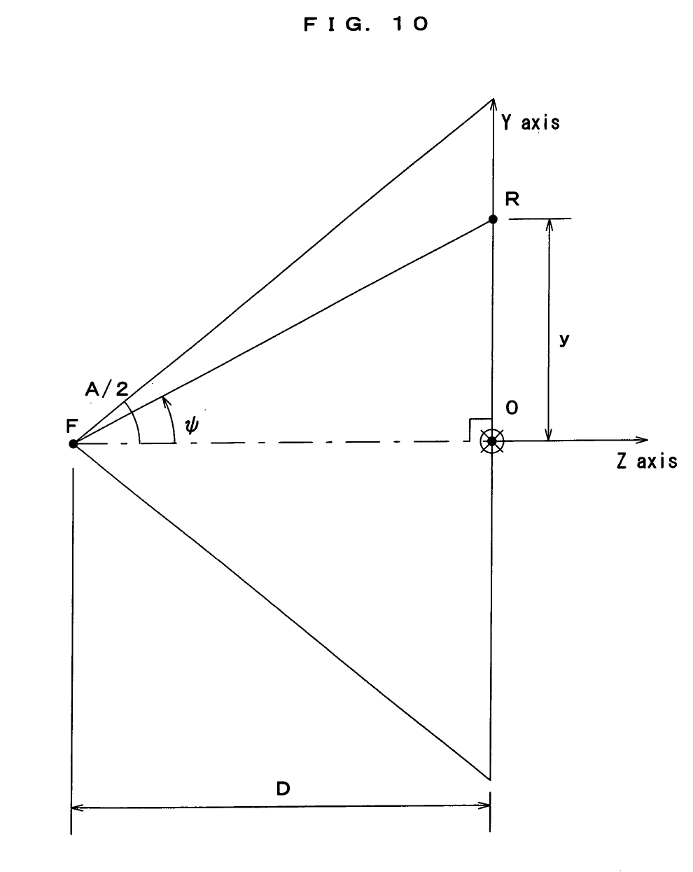

Referring to FIG. 10, the method of controlling the second imaging means according to this embodiment will be described.

FIG. 10 is a view showing the state of perspective projection in the first imaging means 1 (wide angle camera) according to this embodiment as viewed from the right side. The point O denotes the intersection between the plane of projection and the optical axis, and is also the point of origin of the X-Y-Z coordinate system. The point F denotes the focal point of the first imaging means 1 (wide angle camera).

As shown in FIG. 10, an angle φ that is formed by the optical path RF of a light beam irradiated onto the coordinates (x, y) and the plane Z-X can be determined by Expression 1. Here, reference numeral D denotes the focal length (distance FO) of the wide angle camera.

$$φ = {tan}^{- 1} \frac{y}{\sqrt{{D}^{2} + {x}^{2}}} \qquad [ Expression 1 ]$$

Further, an angle θ that is formed between a straight line produced by projecting the optical path RF onto the plane Z-X and the Z axis can be determined by Expression 2.

$$θ = {tan}^{- 1} \frac{x}{D} \qquad [ Expression 2 ]$$

At this time, the second imaging means 2 comprising a rotation camera is disposed adjacent to the first imaging means 1 and the surface of rotation of the rotation camera is parallel with the optical axis of the wide angle camera, and by positioning the rotation camera such that the surface of rotation is parallel with a horizontal line of video images to be acquired by the wide angle camera, when φ and θ that were calculated by the above-described Expression 1 and Expression 2 are applied as the panning angle and tilting angle of the rotation camera, the optical path RF of the incident light is included in a circular cone (or quadrangular pyramid) of the field of view of the rotation camera. More specifically, an object (target) that appears at the position of point R on a video image acquired by the wide angle camera, or a part of the object, also appears in a video image acquired with the rotation camera.

In this connection, preferably a rotation camera comprising pan, tilt, and zoom functions is used as the second imaging means 2, and the second imaging means 2 is zoomed out when switching from a target that is being tracked and imaged by the second imaging means 2 to a new target.

Although there is a problem that output video images may be blurred as a result of rotation when switching from a target that was being tracked and imaged by the second imaging means 2 and changing the imaging direction of the second imaging means 2 to the direction of the new target (when rotating in the direction of a new target), by subjecting the second imaging means to a zoom out operation when switching targets it is possible to prevent blurred video images being output, and the output video images can be smoothly shifted towards the direction of the new target.

Further, by subjecting the second imaging means to a zoom out operation when switching targets, it is possible to ascertain the location from which the imaging direction (imaging range) of the second imaging means 2 shifted (rotated) as well as the location to which it shifted.

Furthermore, when using a rotation camera equipped with pan, tilt, and zoom functions as the second imaging means 2 and displaying an enlarged image of the target tracked by the second imaging means 2 on a monitor, the size of the target is preferably displayed at a constant size.

By providing zoom ratio deciding means that decides the zoom ratio based on the size of the target appearing in the video images to make the size of the target's appearance uniform, previously examining the correspondence between the zoom ratio and viewing angle for the second imaging means 2, and also determining angles formed by the z-x plane and optical paths that are irradiated from the top edge and bottom edge of the target (φ₁ and φ₂, respectively) and angles formed by the x-y plane and optical paths that are irradiated from the left edge and right edge of the target (θ₁ and θ₂, respectively) by means of the X coordinates on the left and right edges of the target (x1 and x2, respectively) and the Y coordinates on the top and bottom edges of the target (y1 and y2, respectively) on video images acquired with the second imaging means 2, a zoom ratio such that these angles are contained within the viewing angle range of the second imaging means 2 can be determined based on the correspondence between the viewing angle and zoom ratio in the second imaging means 2, and designated.

When containing the top edge, left edge, and right edge of a target in the field of view of the second imaging means 2, based on the correspondence between the field of view and the zoom ratio at the second imaging means 2, the zoom ratio is decided within a range in which a horizontal angle of view A_{H} and a vertical angle of view A_{V} fulfill the conditions shown in Expression 3.

In Expression 3, reference character D denotes the focal length of the second imaging means.

$${φ}_{1} = {tan}^{- 1} \frac{{y}_{1}}{D} \\ {φ}_{2} = {tan}^{- 1} \frac{{y}_{2}}{D} \\ {θ}_{1} = {tan}^{- 1} \frac{{x}_{1}}{D} \\ {θ}_{2} = {tan}^{- 1} \frac{{x}_{2}}{D} \\ {θ}_{1} < {A}_{H} / 2 and {θ}_{2} < {A}_{H} / 2 \\ {ϕ}_{1} < {A}_{V} / 2 \qquad [ Expression 3 ]$$

### Embodiment 3

According to the third embodiment of this invention, a method is provided whereby, in addition to the automatic imaging method according to Embodiment 1, when a specific area among previously set sense areas is set as a sense area for entry position imaging (area E) and a target candidate having a common portion with the sense area for entry position imaging (area E) is determined as the target, the second imaging means 2 is rotated to capture the sense area for entry position imaging in which the target is present within the range of the imaging region of the second imaging means 2, and during a period in which the target is present within the sense area for entry position imaging and a pattern of a target candidate having a higher priority than the target in question is not detected, the target within the sense area for entry position imaging is imaged without changing the horizontal rotation of the second imaging means 2.

For example, with respect to the automatic imaging apparatus shown in FIG. 3 or FIG. 5, during a period in which a connecting region T′ that is input to the imaging control means 8 overlaps with the sense area for entry position imaging (area E), the second imaging means 2 is controlled so as to image an object (target) appearing within the sense area for entry position imaging (area E) without changing the horizontal rotation of the second imaging means 2.

Further, when a specific area among previously set sense areas is set as a sense area for preset position imaging (area R) and a target candidate having a common portion with the sense area for preset position imaging (area R) is determined as the target, the second imaging means 2 is rotated to capture a preset position (imaging block) that was previously set in association with the preset position imaging area within the range of the imaging region of the second imaging means 2, and during a period in which the pattern is present within the sense area for preset position imaging and a pattern to be imaged with a higher priority than the target in question is not detected, the preset position (imaging block) is imaged without changing the horizontal rotation of the second imaging means 2.

For example, with respect to the automatic imaging apparatus shown in FIG. 3 or FIG. 5, during a period in which a connecting region T′ that is input to the imaging control means 8 overlaps with the sense area for preset position imaging (area R), the second imaging means 2 is controlled so that a previously set line of sight and range are imaged by the second imaging means 2.

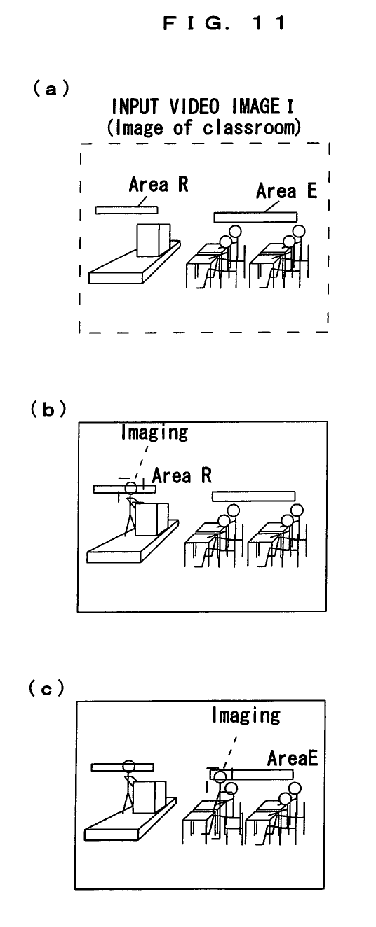

The automatic imaging method according to this embodiment will now be described referring to FIG. 11.

According to the embodiment shown in FIG. 11, on the basis of video images of a monitoring area (classroom) input from the first imaging means, a sense area for preset position imaging (area R) is set at the position of the platform and a sense area for entry position imaging (area E) is set over the heads of seated pupils. The priorities of the sense areas are set such that area R<area E.

Further, with respect to the sense area for preset position imaging (area R), the imaging field of view of the second imaging means 2 that is controlled by the imaging control means 8 is set to be above the platform so that the upper half of the body of the teacher on the platform is imaged. Furthermore, when a pupil that was sitting down stands up and overlaps with the sense area for entry position imaging (area E), the second imaging means 2 is controlled so as to image the pupil that stood up without changing the horizontal rotation of the second imaging means 2.

In FIG. 11(a), since neither the sense area for preset position imaging (area R) nor the sense area for entry position imaging (area E) that were set in the monitoring area (classroom) has a correlation with a significant pattern (target candidate (person), the image is one in which the second imaging means 2 was zoomed out to image the entire classroom.

In FIG. 11(b), since the teacher (target) on the platform has a correlation with the sense area for preset position imaging (area R), the preset position above the platform that was previously set is imaged. During this period, even if the teacher (target) moves to the front, back, right or left, or moves in an upward or downward direction, the position of imaging by the second imaging means 2 remains in the preset position and the second imaging means 2 images the preset position without tracking the teacher (target) or changing the imaging direction.

In FIG. 11(c), since a pupil that stood up (target) has a correlation with the sense area for entry position imaging (area E) and the priorities are such that area E>area R, the pupil (target) that overlaps with the sense area for entry position imaging (area E) is imaged. During this period, although the position of imaging by the second imaging means will go up and down in accordance with an upward or downward movement of the pupil or the height of the appearance in the video images, the imaging position will not move to the left or right even if the pupil moves to the front, back, right or left. More specifically, the imaging direction of the second imaging means 2 images the pupil (target) without changing the horizontal rotation.

It is not necessary to set a sense area for entry position imaging E separately for each individual pupil, and the apparatus can function by setting a single sense area in a band shape as shown in FIG. 11. More specifically, during a period in which the entry of one pupil is detected, stable imaging of that pupil is continued by not moving the imaging position to the right or left even if the pupil moves to the front, back, right or left. Further, by moving the imaging position of the second imaging means upward or downward in accordance with the height of the pupil, the head of a pupil can be captured within the field of view of the second imaging means even if there is a difference in height between each pupil.

Thus, an object of the invention set forth in claim 5 and claim 6 is to provide stable video images by setting constant conditions with respect to the tracking operation of the second imaging means 2 in accordance with the properties of the target.

### Embodiment 4

The automatic imaging method according to the fourth embodiment of this invention is a method that, in addition to the automatic imaging method according to the first embodiment, provides means that designates an area in which tracking and imaging is not to be performed by masking the pattern extraction processing itself.

More specifically, a mask area is set based on video images that were imaged by the first imaging means 1, and even if a pattern is detected within the mask area when video images that were input from the first imaging means 1 underwent pattern detection processing, the pattern within the mask area is not output as a target candidate.

Further, according to the automatic imaging apparatus of the fourth embodiment, by setting an error detection and correction area (area M), it is possible to prevent a situation whereby a movement other than that of a target continues to be erroneously detected as the target in the area being concentrated on, and as a result, the target that must actually be imaged is overlooked.

More specifically, in a case in which a significant pattern was detected within the error detection and correction area and at the periphery of the error detection and correction area when an error detection and correction area (area M) was set based on video images that were imaged with the first imaging means 1, and video images input from the first imaging means 1 were subjected to pattern extraction processing, only the pattern at the periphery of the error detection and correction area is taken as a target candidate. Further, in a case where a pattern of target candidate that was detected with pattern extraction means has a common portion inside the error detection and correction area and does not have a common portion at the periphery of the error detection and correction area, the pattern inside the error detection and correction area is not considered as a target candidate.

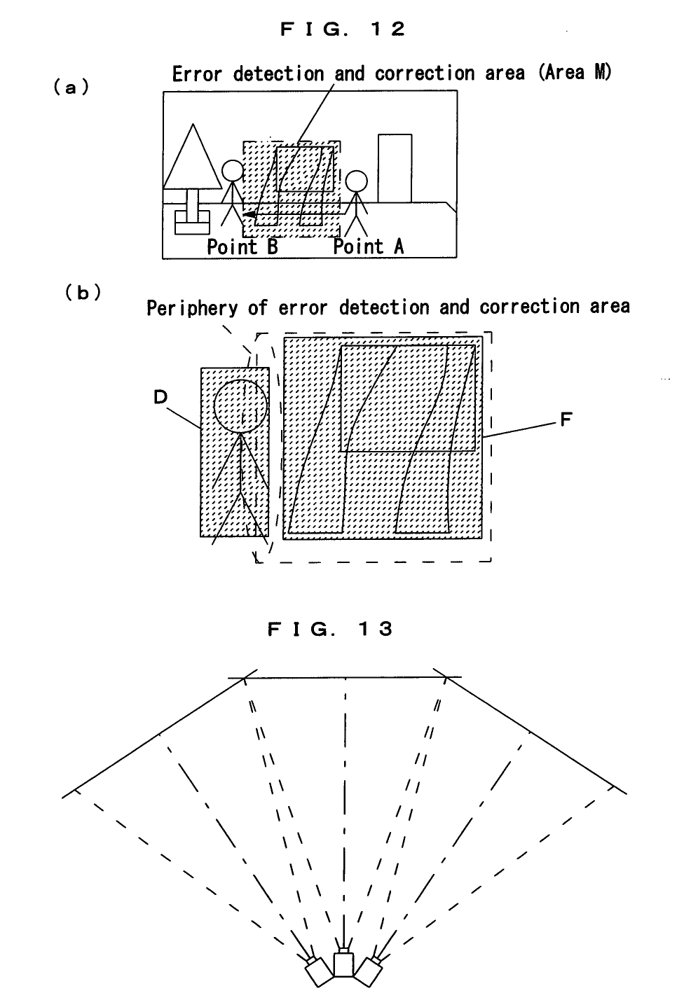

The error detection and correction area according to this embodiment will now be described referring to FIG. 12.

According to this embodiment areas in which movements other than those of a target are concentrated are set in advance as a group of error detection and correction areas {M₁}, and even if the apparatus lapses into erroneous tracking inside those areas, tracking of the target is resumed once the target has left the relevant area.

As shown in FIG. 12(a), when an area including curtains is set in advance as an error detection and correction area {M₁}, when an intruder moves from a point A to a point B the intruder is not detected as a target within the error detection and correction area in the area, and when the intruder reaches the point B (periphery of error detection and correction area) the intruder is reset as the target.

FIG. 12(b) is a view that illustrates the moment at which the intruder leaves the area designated as the error detection and correction area {M₁}. At this time, even if a pattern comprising a difference D between the intruder and the background and a difference F between the curtains and the background is extracted through movement detection processing by the pattern extraction means, since the difference F between the curtains and the background has a common portion with the interior of the error detection and correction area {M₁}, and the difference D between the intruder and the background has a common portion with the periphery of the error detection and correction area {M₁}, the difference D (intruder) is extracted as the pattern of the target, without detecting the difference F (curtains) as a target candidate, and thus the intruder correctly becomes the target.

### Embodiment 5

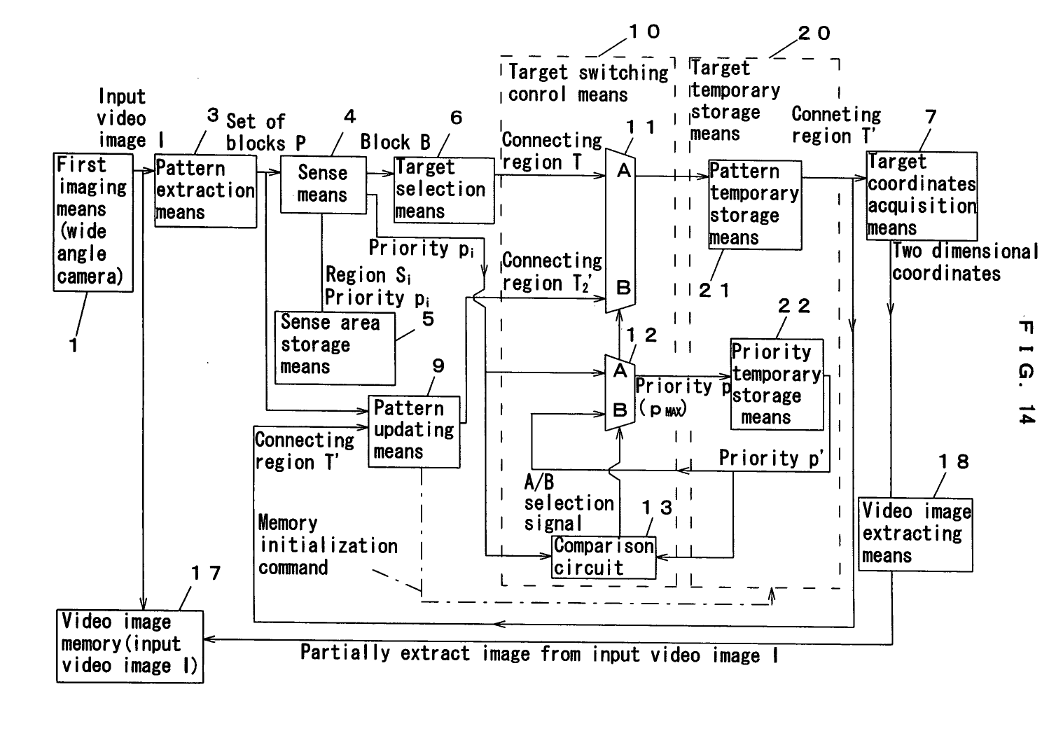

FIG. 13 is a view showing first imaging means of an automatic imaging method according to the fifth embodiment of this invention.

According to this embodiment, first imaging means 1 comprises a plurality of cameras, and overall video images of the monitoring area are acquired by linking the video images input from the plurality of cameras. It is thereby possible to widen the range of the monitoring area that is imaged by the first imaging means.

Three cameras are used in the embodiment illustrated in FIG. 13, and the monitoring area is imaged by linking together video images that were imaged by these cameras, to thereby acquire an overall video image.

### Embodiment 6

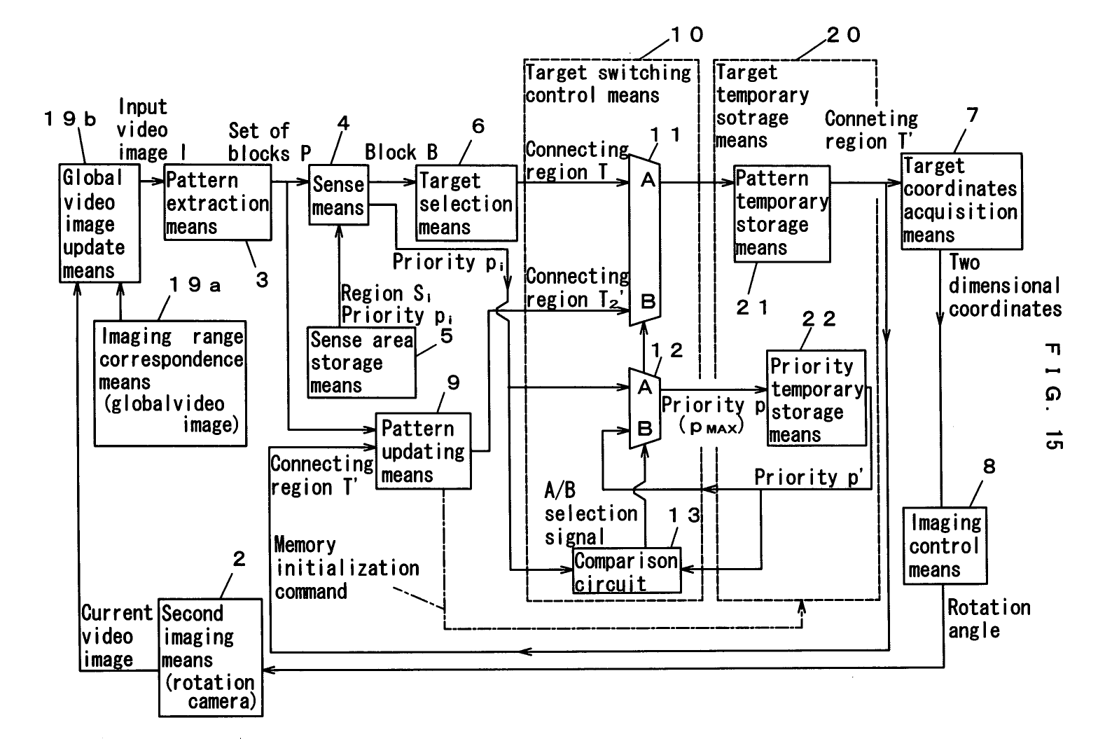

As shown in FIG. 14, an automatic imaging apparatus according to the sixth embodiment includes first imaging means 1 that images an entire monitoring region; pattern extraction means 3 that, for each block obtained by dividing an imaging region of an input video image I acquired from the first imaging means, estimates whether or not a part or all of an object to be tracked and imaged appears in the relevant block, and outputs a set of blocks P in which the object is estimated to appear; sense area storage means 5 that stores N number of regions Sᵢ (i=1, 2, 3 . . . N) of arbitrary shape that were previously set on the imaging region of the input video image I, together with the priority pᵢ (i=1, 2, 3 . . . N) of each region; sense means 4 that determines an overlap between the region Sᵢ and a set of blocks P output by the pattern extraction means 3, and when an overlap exists, outputs a pair consisting of a block B in which the overlap arose and the priority pᵢ of the overlapped region Sᵢ; target selection means 6 that selects the pair with the highest priority (priority p) among the pairs of overlapping block B and the priority pᵢ thereof that were output by the sense means 4, and extracts a connecting region T that includes the block B from the set of blocks P; pattern temporary storage means 21 that temporarily stores the connecting region T selected by the target selection means 6 and outputs the connecting region T as a connecting region T′; priority temporary storage means 22 that temporarily stores the priority p selected by the target selection means 6 and outputs the priority p as a priority p′; and video image extracting means 18 that continuously extracts and outputs images of an area covered by the connecting region T′ on the input video image I; wherein the temporarily stored connecting region T′ is replaced with a connecting region T that was selected from a current set of blocks P that were extracted from a current input video image I and the temporarily stored priority p′ is replaced with a priority p that was obtained together with the connecting region T only in a case where the current priority p is greater than or equal to the priority p′. Further, for a period in which the connecting region T is blank, a connecting region T₂′ that has an overlap with the temporarily stored connecting region T′ is extracted from the current set of blocks P extracted from the current input video image I to update the connecting region T′ with the connecting region T₂′.

That is, according to the sixth embodiment, an electronic cutout means (video image extracting means 18) that partially extracts images of a target from video images input from the first imaging means is provided in place of a camera equipped with pan, tilt, and zoom functions as second imaging means, and when a target is detected by extracting a significant pattern based on an input video image I input from the first imaging means, a video image of a target is partially extracted by the video image extracting means 18 from a video image (overall video image) stored in a video image memory 17 that stores a video image (input video image I) that was captured with the first imaging means 1, and the tracking video images of this target are displayed in enlarged form on a monitor.

More specifically, an automatic imaging method in which video image extracting means 18 that partially extracts video images from an input video image I acquired from first imaging means 1 and outputs the video images is controlled to acquire tracking video images of a target that was detected on the basis of the input video image I from the first imaging means 1, acquires tracking video images of a target by including the steps of: estimating, for each block obtained by dividing an imaging region of input video image I acquired from the first imaging means 1, whether or not a part or all of an object to be tracked and imaged appears in the relevant block, and extracting a set of blocks P in which an object is estimated to appear; setting in advance N number of regions Sᵢ (i=1, 2, 3 . . . N) of arbitrary shape on the imaging region of the input video image I, together with the priority pᵢ (i=1, 2, 3 . . . N) of each region, examining the correlation between the regions Sᵢ and the set of blocks P, and extracting and outputting a connecting region T′ that has an overlap with a region Sᵢ having the highest priority among connecting regions included in the set of blocks P and having an overlap with any region Sᵢ; and continuing to extract images of an area covered by the connecting region T′ from the input video image I.

In this connection, according to this embodiment, to ensure the resolution of video images to be obtained as the output of the second imaging means 2, a camera having an adequate resolution, such as a high definition camera, is used as the first imaging means 1.

According to this embodiment, by acquiring one part of a video image that is input from the first imaging means 1 with electronic cutout means and using the acquired video image in place of a video image obtained with second imaging means 2 comprising a rotation camera, it is no longer necessary to provide a physical imaging apparatus other than the first imaging means 1. Further, control to physically point the second imaging means 2 in a target direction (physical control of imaging direction) is unnecessary.

According to this embodiment, an automatic imaging method that detects a target based on video images of a monitoring area that were imaged with first imaging means 1 and acquires tracking video images of the target with second imaging means 2 to display an enlarged image of the target on a monitor, acquires tracking video images of the target in the same manner as in the first embodiment or second embodiment by determining a single target based on video images imaged with the first imaging means 1, and using the second imaging means 2 to partially extract images of the target from video images of the monitoring area that are input from the first imaging means 1.

The automatic imaging apparatus according to this embodiment includes first imaging means that images a monitoring area, and second imaging means that partially extracts images of a target that was detected on the basis of video images imaged with the first imaging means, wherein the apparatus acquires tracking video images of a target by determining a target from among target candidates acquired by performing pattern extraction processing on the basis of video images input from the first imaging means, and extracting video images of the target with second imaging means by employing: pattern extraction means that extracts significant patterns by subjecting video images input from the first imaging means to pattern extraction processing to output pattern extraction results P (plurality of target candidates); sense area storage means that stores information (region S₁ and priority p₁) of sense areas that are previously set on video images of the entire monitoring region; sense means that examines the correlation between sense areas and target candidates based on the pattern extraction results and sense area information; target selection means that outputs the pattern of a target candidate having a correlation with the sense area of higher priority as the estimated pattern of a new target; target position acquisition means that determines the position of the estimated pattern of the new target on video images input from the first imaging means; and cutout portion determining means that controls the second imaging means based on positional information obtained with the target position acquisition means to determine a cutout portion.

### Embodiment 7

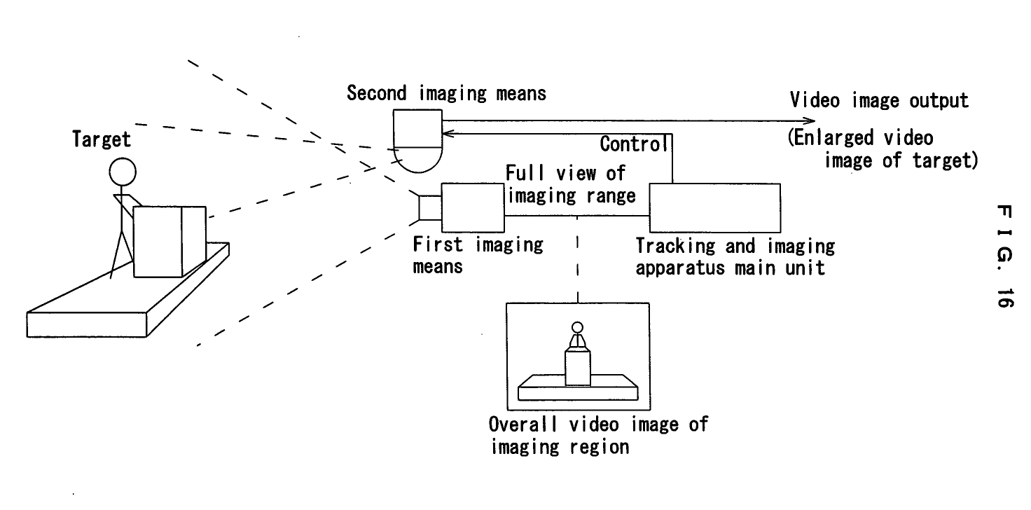

As shown in FIG. 15, an automatic imaging apparatus according to the seventh embodiment includes second imaging means 2 that can change a line of sight; imaging range correspondence means 19a that calculates a range on which the field of view of the second imaging means 2 falls on a virtual global video image of a field of view equivalent to the range of a wide angle field of view that can contain an entire monitoring region from the position of the second imaging means 2; global video image update means 19b that updates contents of a video image in a corresponding range on the global video image with a current video image of the second imaging means 2 to continually output a current global video image; pattern extraction means 3 that, for each block obtained by dividing an imaging region of an input video image I output from the global video image update means 19b, estimates whether or not a part or all of an object to be tracked and imaged appears in the relevant block, and outputs a set of blocks P in which the object is estimated to appear; sense area storage means 5 that stores N number of regions Sᵢ (i=1, 2, 3 . . . N) of arbitrary shape that were previously set on the imaging region of the input video image I, together with a priority pᵢ (i=1, 2, 3 . . . N) of each region; sense means 4 that determines an overlap between the region Sᵢ and a set of blocks P output by the pattern extraction means 3, and when an overlap exists, outputs a pair consisting of a block B in which the overlap arose and a priority pᵢ of the overlapped region Sᵢ; target selection means 6 that selects the pair with the highest priority (priority p) among the pairs of overlapping block B and the priority pᵢ thereof that were output by the sense means 4, and extracts a connecting region T that includes the block B from the set of blocks P; pattern temporary storage means 21 that temporarily stores the connecting region T selected by the target selection means 6 and outputs the connecting region T as a connecting region T′; priority temporary storage means 22 that temporarily stores the priority p selected by the target selection means 6 and outputs the priority p as a priority p′; and imaging control means 8 that controls the second imaging means 2 so as to contain an object appearing in a region covered by the connecting region T′ on the input video image I in the field of view of the second imaging means 2; wherein the temporarily stored connecting region T′ is replaced with a connecting region T that was selected from a current set of blocks P that were extracted from a current input video image I and the temporarily stored priority p′ is replaced with a priority p that was obtained together with the connecting region T only in a case where the current priority p is greater than or equal to the priority p′, and for a period in which the connecting region T is blank, a connecting region T₂′ that has an overlap with the temporarily stored connecting region T′ is extracted from the current set of blocks P extracted from the current input video image I to update the connecting region T′ with the connecting region T₂′.

According to the seventh embodiment, imaging range correspondence means 19a that calculates a range on which the field of view of the second imaging means 2 falls on a virtual global video image of a field of view equivalent to the range of a wide angle field of view that can contain an entire monitoring region from the position of the second imaging means 2; and global video image update means 19b that updates contents of a video image in a corresponding range on the global video image with a current video image input from the second imaging means 2 are provided such that a global video image that is updated on the basis of a current video image of the second imaging means 2 is output as an input video image I. Further, similarly to the first embodiment or second embodiment, tracking video images of a target are acquired by the steps of: estimating, for each block obtained by dividing an imaging region of input video image I, whether or not a part or all of an object to be tracked and imaged appears in the relevant block, and extracting a set of blocks P in which an object is estimated to appear; setting in advance N number of regions Sᵢ (i=1, 2, 3 . . . N) of arbitrary shape in the imaging region of the input video image I, together with the priority pᵢ (i=1, 2, 3 . . . N) of each region, examining the correlation between the regions Sᵢ and the set of blocks P, and extracting and outputting a connecting region T′ that has an overlap with a region Sᵢ having the highest priority among connecting regions included in the set of blocks P and having an overlap with any region Sᵢ; and controlling the second imaging means 2 so as to contain an object appearing in a region covered by the connecting region T′ on the input video image I in the field of view of the second imaging means 2.

That is, according to the seventh embodiment a monitoring area is imaged with a rotation camera equipped with pan, tilt, and zoom functions, a global video image that is updated based on a video image input from the rotation camera is taken as input video image I, and after extracting significant patterns by performing pattern extraction processing for the input video image I to acquire target candidates, the correlation between the target candidates and sense area information (region S₁ and priority p₁) that was previously set based on video images of the entire monitoring region is examined to determine a target candidate having a common portion with a sense area with the higher priority as a target, and the imaging direction of the rotation camera is controlled based on the target position on the input video image I to acquire tracking video images of the target.

The automatic imaging method according to this embodiment is a method in which imaging means using a camera comprises only a single rotation camera with pan, tilt, and zoom functions, and the single rotation camera images a monitoring area and also performs tracking and imaging of a target, wherein sense areas are set on the basis of video images that were input from the rotation camera, pattern extraction processing is also performed based on video images input from the rotation camera, and the correlation between sense areas and target candidates is examined based on the pattern extraction results and sense area information to detect a target.

The rotation camera is zoomed out and rotated in a direction of zero panning and zero tilting (hereunder, referred to as “initial direction”), and sense areas are set with respect to video images acquired with the rotation camera.

Subsequently, pan and tilt angles corresponding to individual image blocks comprising the sense areas are calculated and stored.

At this time, a tilt angle φ and pan angle θ corresponding to an image block positioned at coordinates (x,y) on the video image of the rotation camera are respectively represented by Expression 4. In Expression 4, reference character D denotes focal length.

$$φ = {tan}^{- 1} \frac{y}{\sqrt{{D}^{2} + {x}^{2}}} \\ θ = {tan}^{- 1} \frac{x}{D} \qquad [ Expression 4 ]$$

If the direction and angular field of view of the rotation camera can be given based on the correspondence between the angles and image blocks as described above, an image block corresponding to an arbitrary position in the field of view can be calculated.

It is possible to extract target candidates by pattern extraction processing in only the range of image blocks contained within the field of view at this time.

That is, according to this embodiment a new target is sensed in only a sense area present within the field of view of the rotation camera. More specifically, a target is determined by examining the correlation between pattern extraction results and sense areas that are present within the field of view of the rotation camera, and when a target was detected the target can be tracked by changing the imaging direction of the rotation camera and an enlarged image of the target is acquired by changing the zoom ratio.

According to this embodiment, when a target is not detected the rotation camera is pointed in a preset imaging direction (for example, the initial direction) and zoomed out, and pattern extraction processing is performed based on video images that were input from the zoomed out rotation camera.

When a target that was being tracked and imaged by the rotation camera can no longer be detected, by zooming out (changing the zoom ratio) the rotation camera that had been imaging the target while maintaining the imaging direction of the rotation camera, tracking and imaging of the target can be performed when the target can be detected again, such as in a case where the target that was being tracked and imaged by the rotation camera could not be detected temporarily because the target is concealed in the shadow of a background object.

1. An automatic imaging method that controls second imaging means (2) that can change a line of sight, and performs tracking and imaging of a target that is detected based on an input video image I of first imaging means (1) to thereby acquire tracking video images of the target, wherein the video images of a target are acquired by steps comprising:
for each block obtained by dividing an imaging region of input video image I acquired from the first imaging means 1, estimating whether or not a part or all of an object to be tracked and imaged appears in the block, and extracting a set of blocks P in which the object is estimated to appear;
setting in advance N number of regions Sᵢ (i=1, 2, 3 . . . N) of arbitrary shape on an imaging region of the input video image I, together with a priority pᵢ (i=1, 2, 3 . . . N) of each region, examining a correlation between the regions Sᵢ and the set of blocks P, and extracting and outputting a connecting region T′ that has an overlap with a region Sᵢ having a highest priority among connecting regions included in the set of blocks P and having an overlap with any of the regions Sᵢ; and
controlling the second imaging means (2) so as to contain an object appearing in a region covered by a connecting region T′ on input video image I in a field of view of the second imaging means (2).

2. An automatic imaging method that controls video image extracting means (18) that partially extracts a video image from an input video image I that is acquired from first imaging means (1) and outputs the extracted video image, to acquire tracking video images of a target based on the input video image I of the first imaging means (1), wherein the video images of a target are acquired by steps comprising:
for each block obtained by dividing an imaging region of input video image I acquired from the first imaging means (1), estimating whether or not a part or all of an object to be tracked and imaged appears in the block, and extracting a set of blocks P in which the object is estimated to appear;
setting in advance N number of regions Sᵢ (i=1, 2, 3 . . . N) of arbitrary shape on an imaging region of the input video image I, together with a priority pᵢ (i=1, 2, 3 . . . N) of each region, examining a correlation between the regions Sᵢ and the set of blocks P, and extracting and outputting a connecting region T′ that has an overlap with a region Sᵢ having a highest priority among connecting regions included in the set of blocks P and having an overlap with any of the regions Sᵢ; and
continuing to extract an image of an area covered by a connecting region T′ from the input video image I.

3. The automatic imaging method according to claim 1 or 2, further comprising providing: imaging range correspondence means (19a) that calculates a range on which a field of view of the second imaging means (2) falls on a virtual global video image of a field of view that is equivalent to a range of a wide angle field of view that can contain an entire monitoring region from a position of the second imaging means (2); and global video image update means (19b) that updates contents of a video image of a corresponding range on the global video image with a current video image that is input from the second imaging means (2); and wherein a global video image that is updated based on a current video image of second imaging means (2) is output as input video image I.

4. The automatic imaging method according to claim 1 or 2 which is a method that examines a correlation between previously set regions Sᵢ and a set of blocks P, extracts a connecting region T that has an overlap with a region Sᵢ having a highest priority among connecting regions included in the set of blocks P and having an overlap with any of the regions Sᵢ, and temporarily stores the connecting region T and a priority p of the region Sᵢ overlapping therewith, and
outputs the temporarily stored connecting region T as a connecting region T′, outputs the temporarily stored priority p as a priority p′, and controls the second imaging means (2) so as to contain in a field of view of the second imaging means (2) an object that appears in a region that is covered by the connecting region T′ on an input video image I, to thereby acquire a tracking video image of a target; wherein:
the connecting region T′ that is temporarily stored is replaced with a connecting region T that is selected from a current set of blocks P that are extracted from a current input video image I and the priority p′ that is temporarily stored is replaced with a priority p obtained together with the connecting region T only in a case where the current priority p is greater than or equal to the priority p′; and
for a period in which the connecting region T is blank, a connecting region T₂′ that has an overlap with the temporarily stored connecting region T′ is extracted from a current set of blocks P that is extracted from a current input video image I, to update the connecting region T′ with the connecting region T₂′.

5. The automatic imaging method according to claim 1 or 2, wherein an area E is previously set as a sense area for entry position imaging on an imaging region of an input video image I; and
during a period in which the area E and the connecting region T′ overlap, tracking video images are acquired of a target appearing in the region E, without horizontally changing a field of view of the second imaging means (2).

6. The automatic imaging method according to claim 1 or 2, wherein an area R is previously set as a sense area for preset position imaging on an imaging region of an input video image I; and
during a period in which the area R and the connecting region T′ overlap, a field of view of the second imaging means (2) is in a preset direction and range.

7. The automatic imaging method according to claim 4, wherein a connecting region M is previously set as an error detection and correction area on an imaging region of an input video image I;
and when a connecting region T′ is included in the connecting region M and an overlap arose between a periphery of the connecting region M and a set of blocks P that are extracted from the input video image I,
the connecting region T′ that is temporarily stored is replaced with a connecting region T′ of a set P that includes an overlap between the connecting region M and the set of blocks P.

8. An automatic imaging apparatus, comprising:
first imaging means (1) that images an entire monitoring region;
second imaging means (27 that can change a line of sight;
pattern extraction means (3) that, for each block obtained by dividing an imaging region of an input video image I acquired from the first imaging means, estimates whether or not a part or all of an object to be tracked and imaged appears in the block, and outputs a set of blocks P in which the object is estimated to appear;
sense area storage means (5) that stores N number of regions Sᵢ (i=1, 2, 3 . . . N) of arbitrary shape that are previously set on an imaging region of an input video image I, together with a priority pᵢ (i=1, 2, 3 . . . N) of each region,
sense means (4) that determines an overlap between the regions Sᵢ and a set of blocks P that is output by the pattern extraction means (3), and when an overlap exists, outputs a pair consisting of a block B in which the overlap appears and a priority pᵢ of the region Sᵢ having the overlap;
target selection means (6) that selects a pair with a highest priority (priority p) among pairs of overlapping block B and priority pᵢ thereof that are output by the sense means (4), and extracts a connecting region T that includes the block B from the set of blocks P;
pattern temporary storage means (21) that temporarily stores the connecting region T selected with the target selection means (6), and outputs the connecting region T as a connecting region T′;
priority temporary storage means (22) that temporarily stores a priority p that is selected by the target selection means (6) and outputs the priority p as a priority p′; and
imaging control means (8) that controls the second imaging means (2) so as to contain an object appearing in a region covered by the connecting region T′ on the input video image I in a field of view of the second imaging means (2);
wherein the connecting region T′ that is temporarily stored is replaced with a connecting region T that is selected from a current set of blocks P that are extracted from a current input video image I and the priority p′ that is temporarily stored is replaced with a priority p that is obtained together with the connecting region T only in a case where the current priority p is greater than or equal to the priority p′, and
during a period in which the connecting region T is blank, a connecting region T₂′ that has an overlap with the temporarily stored connecting region T′ is extracted from a current set of blocks P extracted from a current input video image I, to update the connecting region T′ with the connecting region T₂′.

9. An automatic imaging apparatus, comprising:
first imaging means (1) that images an entire monitoring region;
pattern extraction means (3) that, for each block obtained by dividing an imaging region of an input video image I acquired from the first imaging means, estimates whether or not a part or all of an object to be tracked and imaged appears in the block, and outputs a set of blocks P in which the object is estimated to appear;
sense area storage means (5) that stores N number of regions Sᵢ (i=1, 2, 3 . . . N) of arbitrary shape that are previously set on an imaging region of an input video image I, together with a priority pᵢ (i=1, 2, 3 . . . N) of each region,
sense means (4) that determines an overlap between the regions Sᵢ and a set of blocks P that is output by the pattern extraction means (3), and when an overlap exists, outputs a pair consisting of a block B in which the overlap appears and a priority pᵢ of the region Sᵢ having the overlap;
target selection means (6) that selects a pair with a highest priority (priority p) among pairs of overlapping block B and priority pᵢ thereof that are output by the sense means (4), and extracts a connecting region T that includes the block B from the set of blocks P;
pattern temporary storage means (21) that temporarily stores the connecting region T selected by the target selection means (6), and outputs the connecting region T as a connecting region T′;
priority temporary storage means (22) that temporarily stores a priority p that is selected by the target selection means (6) and outputs the priority p as a priority p′; and
video image extracting means (18) that continuously extracts images of a region covered by the connecting region T′ on the input video image I and outputs the images;
wherein the connecting region T′ that is temporarily stored is replaced with a connecting region T that is selected from a current set of blocks P that are extracted from a current input video image I and the priority p′ that is temporarily stored is replaced with a priority p that is obtained together with the connecting region T only in a case where the current priority p is greater than or equal to the priority p′, and
during a period in which the connecting region T is blank, a connecting region T₂′ that has an overlap with the temporarily stored connecting region T′ is extracted from a current set of blocks P extracted from a current input video image I, to update the connecting region T′ with the connecting region T₂′.

10. An automatic imaging apparatus, comprising:
second imaging means (2) that can change a line of sight;
imaging range correspondence means (19a) that calculates a range on which a field of view of the second imaging means (2) falls on a virtual global video image of a field of view that is equivalent to a range of a wide angle field of view that can contain an entire monitoring region from a position of the second imaging means (2);
global video image update means (19b) that updates contents of a video image of a corresponding range on the global video image with a current video image from the second imaging means (2), to continuously output a current global video image;
pattern extraction means (3) that, for each block obtained by dividing an imaging region of an input video image I that is output from the global video image update means (19b), estimates whether or not a part or all of an object to be tracked and imaged appears in the block, and outputs a set of blocks P in which the object is estimated to appear;
sense area storage means (5) that stores N number of regions Sᵢ (i=1, 2, 3 . . . N) of arbitrary shape that are previously set on an imaging region of an input video image I, together with a priority pᵢ (i=1, 2, 3 . . . N) of each region;
sense means (4) that determines an overlap between the regions Sᵢ and a set of blocks P output by the pattern extraction means (3), and when an overlap exists, outputs a pair consisting of a block B in which the overlap appears and a priority pᵢ of the region Sᵢ having the overlap;
target selection means (6) that selects a pair with a highest priority (priority p) among pairs of overlapping block B and priority pᵢ thereof that are output by the sense means (4), and extracts a connecting region T that includes the block B from the set of blocks P;
pattern temporary storage means (21) that temporarily stores the connecting region T selected by the target selection means (6), and outputs the connecting region T as a connecting region T′;
priority temporary storage means (22) that temporarily stores a priority p that is selected by the target selection means (6) and outputs the priority p as a priority p′; and
imaging control means (8) that controls the second imaging means (2) so as to contain an object appearing in a region covered by the connecting region T′ on the input video image I in a field of view of the second imaging means (2);
wherein the connecting region T′ that is temporarily stored is replaced with a connecting region T that is selected from a current set of blocks P that are extracted from a current input video image I and the priority p′ that is temporarily stored is replaced with a priority p that is obtained together with the connecting region T only in a case where the current priority p is greater than or equal to the priority p′, and
during a period in which the connecting region T is blank, a connecting region T₂′ that has an overlap with the temporarily stored connecting region T′ is extracted from a current set of blocks P extracted from a current input video image I, to update the connecting region T′ with the connecting region T₂′.
